(19) United States
(12) Patent Application Publication
(10) Pub. No.: US 2024/0066838 A1
(43) Pub. Date: Feb. 29, 2024

(54) WINDSHIELD FOR VEHICLE AND ITS MANUFACTURING METHOD

(71) Applicant: AGC Inc., Tokyo (JP)

(72) Inventor: Naoki TESHIMA, Tokyo (JP)

(73) Assignee: AGC Inc., Tokyo (JP)

(21) Appl. No.: 18/239,353

(22) Filed: Aug. 29, 2023

(30) Foreign Application Priority Data
Aug. 31, 2022 (JP) 2022-137863

(51) Int. Cl. B32B 17/10; B60J 1/02

(52) U.S. Cl. CPC B32B 17/10036; B32B 17/10201; B32B 17/1022; B32B 17/10293; B32B 17/1044; B32B 17/10981; B60J 1/02; B32B 2307/202; B32B 2307/206; B32B 2307/4026

(57) ABSTRACT

A windshield for vehicle includes a glass plate with a terminal including a first glass plate, a conductor made of a material containing silver and glass frit and including a terminal joint portion, and a terminal joined to the terminal joint portion of the conductor through lead-free solder, in which the glass plate with the terminal further includes an inorganic thin film between the first glass plate and the terminal joint portion, the inorganic thin film including at least one metal compound layer, having an overall thickness of 1,000 nm or smaller, and having a single-layer structure or a laminated structure, and at least an outermost surface of the inorganic thin film having an insulating property.

### INCORPORATION BY REFERENCE

This application is based upon and claims the benefit of priority from Japanese patent application No. 2022-137863, filed on Aug. 31, 2022, the disclosure of which is incorporated herein in its entirety by reference.

### BACKGROUND

The present disclosure relates to a windshield for vehicle and its manufacturing method.

A laminated glass in which a plurality of glass plates are bonded together or a tempered glass is suitably used for a window glass for vehicle such as an automotive. In general, a glass plate that is used as a material for a windshield for vehicle is formed into a shape having a curved surface by thermoforming, and a light-shielding layer is formed in the peripheral area of the glass plate.

A windshield for vehicle including a conductor that includes or is connected to an electric function portion, and a feeding member such as a harness and a cable has been known. Examples of electric function portions include an electric heating line, an electric heating layer, an antenna, a dimming layer, a light-emitting element, and a combination thereof. The conductor may include a feeding portion for feeding electricity to the electric function portion.

In this specification, a glass plate including a conductor is referred to as a “glass plate with a conductor”.

There are cases where in order to melt frost, snow, ice and the like adhering to wipers and to prevent the wipers from being frozen, a conductor including an electric function portion composed of at least one electric heating line, and a feeding portion composed of a pair of feeding electrodes (also referred to as busbars) and the like is formed at the lower end, or the side edges or the like of a windshield for vehicle.

Further, there are cases where an optical apparatus including an optical device that acquires information about an area ahead of a vehicle, such as an ADAS (Advanced Driver Assistance systems) camera, LiDAR (Light Detection And Ranging), a radar, and an optical sensor, and a housing referred to as a bracket or the like that houses the optical device is provided on the inner surface of a windshield for vehicle in order to perform automatic driving and/or to prevent a collision accident. In such a configuration, in order to improve the accuracy of the sensing by the optical apparatus, in some cases, a conductor including an electric function portion composed of at least one electric heating line for removing condensation, frost, snow, ice and the like and preventing them from being formed or adhering to wipers or the like, and a feeding portion composed of a pair of feeding electrodes (busbars) or the like is formed in a glass portion of the windshield or the like located in front of the optical device.

In a windshield for vehicle like the one described above, a feeding member such as a harness and a cable is joined (e.g., bonded) to each of the feeding electrodes of the feeding portion. As the feeding portion is not provided to generate heat and requires an area for joining the feeding member thereto, it is designed to have a width wider than that of the electric heating line. Therefore, in the related art, the feeding portion is typically formed on the light-shielding layer so that it is not visible to people outside the vehicle.

### SUMMARY

The light-shielding layer can be formed, for example, by applying a ceramic paste containing a black pigment and glass frit to the glass plate and firing the applied ceramic paste. The conductor can be formed, for example, by applying a silver-containing paste containing a silver powder and glass frit to the glass plate and firing the applied silver-containing paste. The firing of the ceramic paste or the silver-containing paste can be performed simultaneously with the thermoforming of the glass plate.

In the related art, the joining between the feeding portion and the feeding member is carried out by using solder.

For example, a terminal is fixed to the tip of the feeding member such as a wire harness, and this terminal is joined to the feeding portion by using solder. Examples of solder include leaded solder and lead-free solder. In recent years, there is concern about the effect of lead on the environmental and legal restrictions on leaded solder are spreading, so it is desired to use lead-free solder.

In general, the melting point of lead-free solder is higher than that of leaded solder, and is, for example, about 220° C., so it is necessary to perform solder joining at a higher temperature (for example, about 300° C.). In a glass plate with a conductor, when a conductor and a terminal are joined to each other by lead-free solder, the glass plate is locally heated to a high temperature and the temperature locally decreases from the high temperature to a normal temperature. When the temperature decreases, due to the difference between the thermal expansion coefficient of the glass plate and that of the lead-free solder, a difference occurs between the amount of the thermal shrinkage of the glass plate and that of the lead-free solder, thus causing a stress (specifically, a tensile stress) in the glass plate with the conductor. Further, in some cases, this stress remains even after the temperature has decreased. This residual stress may cause cracks in the glass plate after a windshield for vehicle is manufactured. Further, since lead-free solder does not contain lead, which has a low elastic modulus, it has a higher elastic modulus than that of the leaded solder and is less likely to deform than leaded solder is. Therefore, a residual stress that has occurred in the glass plate with the conductor is less likely to be reduced. For these reasons, when a conductor and a terminal are joined to each other by lead-free solder, a problem that a residual stress occurs in the glass plate after the joining and cracks may occur after the manufacturing due to the residual stress could occur.

In this specification, a glass plate including a conductor and a terminal is also referred to as a “glass plate with a terminal”.

When the breaking strength of a glass plate to which terminals have already been attached is low, there is a risk that cracks occur in the glass when an external force is applied to the glass plate. In particular, when terminals are joined to a feeding portion formed on a light-shielding layer by using lead-free solder, the breaking strength of the glass plate to which the terminals have already been attached tends to decrease.

In this specification, “the breaking strength of a glass plate to which terminals have not been attached yet or have already been attached” is an amount of a load that is applied to the glass plate to which the terminals have not been attached yet or have already been attached at the point when it is broken, and can be measured by a method described in the “Example” section (which will be described later).

Examples of the related art of the present disclosure include International Patent Publications No. WO2011/138600 and No. WO2020/150324.

International Patent Publication No. 2011/138600 relates to a method for a solder connection with a conductor formed in a thin glass sheet. In this literature, it is mentioned that: “by printing a conductor (6) directly on a sheet (1), a more reliable solder connection (7) of a second conductor (8) to the conductor (6) becomes easier; the conductor (7) can be, for example, a heating element or a busbar in a wiper rest area, and is visually concealed from people outside the vehicle owing to a layer (5)” (see FIG. 2 and its description). Further, in the “Example” section, the effect for preventing cracks after the solder joining is carried out in the case where the conductor (6) is printed directly on the sheet (1) is described.

According to the technology disclosed in the present disclosure, it is possible to enhance the breaking strength of a glass plate to which terminals have already been attached even further compared to that obtained by the technology disclosed in International Patent Publication No. WO2011/138600.

International Patent Publication No. WO2020/150324 discloses glazing for vehicle including:
a first glass plate;
a second glass plate;
a polymer intermediate film; and
a coating on at least one surface of at least one of the first and second glass plates, with a conductive material adhering thereon, the conductive material having not being heat-treated at a temperature higher than 500° C. (claim 17).

The above-described coating is a heat-generatable infrared reflection (IRR) coating or the like containing a silver layer (claims 20 to 24).

In International Patent Publication No. WO2020/150324, the above-described conductive material can include a busbar, and this busbar can be formed using solder paste (claims 26 and 29).

In International Patent Publication No. WO2020/150324, it is stated that “while the metallic silver layer in the heat-generatable IRR coating is conductive, most of the other layers, including the top layer, are dielectric or insulators, hence nonconductive”. In International Patent Publication No. WO2020/150324, it is also stated that “as the conductive material (552) is etched into the coating (536), the conductive material (552) reaches the conductive layer (538) of the coating (536), forming an electric connection for the formation of the busbar” (FIG. 5).

As can be understood from the above descriptions, in International Patent Publication No. WO2020/150324, the busbar is a feeding electrode for the conductor layer contained in the coating. In International Patent Publication No. WO2020/150324, the conductor layer contained in the coating and the busbar are electrically connected to each other, and the conductor layer contained in the coating and the busbar are not insulated from each other. The purpose of the provision of the coating, which is disposed between the glass plate and the feeding portion which is provided to feed electricity to other electric function portions other than the coating, is not to enhance the breaking strength of the glass plate to which terminals have already been attached.

The present disclosure has been made in view of the above-described circumstances, and an object thereof is to provide a windshield for vehicle which includes a part where a conductor and a terminal are joined to each other by using lead-free solder, and of which the breaking strength of the glass plate to which terminals have already been attached can be enhanced.

The present disclosure provides a windshield for vehicle and its manufacturing method described hereinafter.
[1] A windshield for vehicle comprising a laminated glass in which a first glass plate and a second glass plate are bonded together with an intermediate film interposed therebetween, wherein
   the laminated glass comprises a glass plate with a terminal, comprising the first glass plate, a conductor formed on an interior surface of the first glass plate, and the terminal, the conductor being made of a material containing silver and glass frit, and comprising a terminal joint portion to which the terminal is joined, the terminal being joined to the terminal joint portion of the conductor through lead-free solder,
   the conductor comprises an electric function portion or is electrically connected to an electric function portion,
   the conductor comprises a feeding portion for feeding electricity to the electric function portion, and
   the feeding portion comprises the terminal joint portion, and the glass plate with the terminal further comprises an inorganic thin film between the first glass plate and the terminal joint portion, the inorganic thin film including at least one metal compound layer, having an overall thickness of 1,000 nm or smaller, and having a single-layer structure or a laminated structure, and at least an outermost surface of the inorganic thin film having an insulating property.
[2] The windshield for vehicle according to item [1], wherein the inorganic thin film is a vapor deposition film.
[3] The windshield for vehicle according to item [1] or [2], wherein
   the terminal joint portion is formed directly above the inorganic thin film, a first light-shielding layer is formed between the interior surface of the first glass plate and at least a part of the conductor other than the terminal joint portion, and
   a second light-shielding layer covering the terminal joint portion of the conductor is formed, in a plan view, on an exterior surface of the first glass plate and at least one of two surfaces of the second glass plate.
[4] The windshield for vehicle according to any one of items [1] to [3], wherein the inorganic thin film includes at least one metal compound layer containing at least one metal compound selected from the group consisting of an oxide, a nitride, and an oxynitride of at least one metal element selected from the group consisting of B, Al, Si, Ti, Cr, Ni, Zn, Ga, Y, Zr, Nb, In, Sn, Hf, Ta and W.
[5] The windshield for vehicle according to any one of items [1] to [4], wherein
   the inorganic thin film includes at least one insulating metal compound layer containing at least one insulating metal compound selected from the group consisting of an oxide, a nitride, and an oxynitride of at least one metal element selected from the group consisting of B, Al, Si, Ti, Cr, Ni, Ga, Y, Zr, Nb, Hf, Ta and W, and
   when the inorganic thin film has the laminated structure, at least the outermost surface layer of the inorganic thin film is the insulating metal compound layer.
[6] The windshield for vehicle according to any one of items [1] to [5], wherein
   the inorganic thin film includes at least one insulating metal compound layer and at least one conductor layer containing at least one substance selected from the group consisting of a metal and a conductive metal compound, and
   at least the outermost surface layer of the inorganic thin film is the insulating metal compound layer.
[7] The windshield for vehicle according to any one of items [1] to [6], wherein the inorganic thin film is a functional film having at least one function selected from the group consisting of a low reflection function, a low emission function, a water repellent function, an electric heating function, an antifogging function, an antifouling function, an infrared-light blocking function, an ultraviolet-light blocking function, and a p-polarized-light reflection function.
[8] The windshield for vehicle according to any one of items [1] to [7], wherein the interior surface of the first glass plate is a surface on an intermediate film side of the first glass plate and has an exposed portion not covered by the second glass plate, and the terminal joint portion of the conductor is formed in this exposed portion.
[9] The windshield for vehicle according to any one of items [1] to [7], wherein the interior surface of the first glass plate is a surface on a side of the first glass plate opposite to an intermediate film side thereof.
[10] The windshield for vehicle according to item [9], wherein
   a first light-shielding layer is formed between the interior surface of the first glass plate and at least a part of the conductor other than the terminal joint portion, and
   a second light-shielding layer covering the terminal joint portion of the conductor is formed, in a plan view, on a surface on the intermediate film side of the second glass plate.
[11] The windshield for vehicle according to item [10], wherein
   the glass plate with the terminal includes an optical apparatus mounting area and a light-transmitting portion, the optical apparatus mounting area being, in a plan view, an area in which an optical apparatus is mounted, and the light-transmitting portion being a portion which is located inside the optical apparatus mounting area and through which external incident light entering the optical apparatus and/or outgoing light exiting from the optical apparatus passes,
   the first light-shielding layer is formed so as to surround, in the plan view, at least a part of the light-transmitting portion, and
   the conductor comprises an electric heating line formed inside the light-transmitting portion, the feeding portion formed outside the light-transmitting portion, and a connection line formed outside the light-transmitting portion and connecting the electric heating line and the feeding portion.
[12] The windshield for vehicle according to any one of items [1] to [11], wherein a feeding member formed of a round lead or a foil lead is fixed to the terminal.
[13] A method for manufacturing a windshield for vehicle, wherein
   the windshield for vehicle comprises: a laminated glass in which a first glass plate and a second glass plate are bonded together with an intermediate film interposed therebetween; and
   the laminated glass comprising a glass plate with a terminal, comprising the first glass plate, a conductor formed on an interior surface of the first glass plate, and the terminal,
   the conductor comprising a terminal joint portion to which the terminal is joined, the terminal being joined to the terminal joint portion of the conductor,
   the conductor comprises an electric function portion or is electrically connected to an electric function portion, the conductor comprises a feeding portion for feeding electricity to the electric function portion, and the feeding portion comprises the terminal joint portion, and
   the method comprises:
   forming an inorganic thin film in at least a formation area of the terminal joint portion on the interior surface of the first glass plate by a vapor deposition method, the inorganic thin film including at least one metal compound layer, having an overall thickness of 1,000 nm or smaller, and having a single-layer structure or a laminated structure, and at least an outermost surface of the inorganic thin film having an insulating property (S11);
   applying a silver-containing paste to the interior surface of the first glass plate, on which the inorganic thin film has been formed, the silver-containing paste containing silver and glass frit as a material for the conductor (S13);
   forming the conductor by firing the first glass plate, to which the material for the conductor has been applied, and thereby obtaining a glass plate with a conductor (S14); bonding the glass plate with the conductor and the second glass plate together with the intermediate film interposed therebetween (S15); and
   joining the terminal to the terminal joint portion included in the conductor through lead-free solder (S16).
[14] The method for manufacturing the windshield for vehicle according to item [13], wherein
   in the windshield for vehicle, the terminal joint portion is formed directly above the inorganic thin film, and a first light-shielding layer is formed between the interior surface of the first glass plate and at least a part of the conductor other than the terminal joint portion,
   the method further comprises, between the steps (S11) and (S13), applying a ceramic paste containing a black pigment and glass frit, as a material for the first light-shielding layer, to the interior surface of the first glass plate, on which the inorganic thin film has been formed (S12), and
   in the step (S14), the first light-shielding layer and the conductor are formed by firing the first glass plate, to which the material for the first light-shielding layer and the material for the conductor have been applied, and the glass plate with the conductor is thereby obtained.

In the windshield for vehicle according to the present disclosure, the glass plate with the terminal includes the inorganic thin film between the glass plate and the terminal joint portion, the inorganic thin film including at least one metal compound layer, having an overall thickness of 1,000 nm or smaller, and having a single-layer structure or a laminated structure, and at least the outermost surface of the inorganic thin film having an insulating property. In the above-described structure, the presence of the inorganic thin film can enhance the breaking strength of the glass plate to which terminals have already been attached.

According to the present disclosure, it is possible to provide a windshield for vehicle which includes a part where a conductor and a terminal are joined to each other by using lead-free solder, and of which the breaking strength of the glass plate to which the terminal has already been attached can be enhanced.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is an overall plan view of a windshield for vehicle according to a first embodiment of the present disclosure;

FIG. 2 is a partially enlarged plan view of FIG. 1;

FIG. 3 is a cross-sectional diagram taken along a line in FIG. 2;

FIG. 4 is a partially enlarged cross-sectional diagram of FIG. 3 (of a partially enlarged cross-sectional diagram of a laminated structure of Terminal/Lead-Free Solder/Feeding Electrode including Terminal Joining Portion/Inorganic Thin Film/First Glass Plate);

FIG. 5 is a partially enlarged cross-sectional diagram of FIG. 4 (of a partially enlarged cross-sectional diagram of a laminated structure of Feeding Electrode/Inorganic Thin Film/First Glass Plate including a terminal joint portion);

FIG. 6A is a process diagram of a method for manufacturing a windshield for vehicle according to the first embodiment;

FIG. 6B is a process diagram of the method for manufacturing the windshield for vehicle according to the first embodiment;

FIG. 6C is a process diagram of the method for manufacturing the windshield for vehicle according to the first embodiment;

FIG. 6D is a process diagram of the method for manufacturing the windshield for vehicle according to the first embodiment;

FIG. 6E is a process diagram of the method for manufacturing the windshield for vehicle according to the first embodiment;

FIG. 6F is a process diagram of the method for manufacturing the windshield for vehicle according to the first embodiment;

FIG. 6G is a process diagram of the method for manufacturing the windshield for vehicle according to the first embodiment;

FIG. 7 is a cross-sectional diagram showing an example of a change in the design according to the first embodiment;

FIG. 8A is an overall plan view of a windshield for vehicle according to a second embodiment in accordance with the present disclosure;

FIG. 8B is an overall plan view of an outer glass plate of the windshield for vehicle according to the second embodiment;

FIG. 9 is a partially enlarged plan view of FIG. 8A;

FIG. 10A is a cross-sectional diagram taken along a line XA-XA in FIG. 9;

FIG. 10B is a cross-sectional diagram taken along a line XB-XB in FIG. 9;

FIG. 10C is a cross-sectional diagram taken along a line XC-XC in FIG. 9;

FIG. 11A is a process diagram of a method for manufacturing a windshield for vehicle according to the second embodiment;

FIG. 11B is a process diagram of the method for manufacturing the windshield for vehicle according to the second embodiment;

FIG. 11C is a process diagram of the method for manufacturing the windshield for vehicle according to the second embodiment;

FIG. 11D is a process diagram of the method for manufacturing the windshield for vehicle according to the second embodiment;

FIG. 11E is a process diagram of the method for manufacturing the windshield for vehicle according to the second embodiment;

FIG. 11F is a process diagram of the method for manufacturing the windshield for vehicle according to the second embodiment;

FIG. 11G is a process diagram of the method for manufacturing the windshield for vehicle according to the second embodiment;

FIG. 12A is a graph showing results of evaluations of a glass plate (a glass plate with a conductor) to which terminals have not been attached yet; and

FIG. 12B is a graph showing results of evaluations of a glass plate (a glass plate with terminals) to which terminals have already been attached.

### DESCRIPTION OF EMBODIMENTS

In general, a thin-film structure is referred to as a “film”, “sheet” or the like depending on its thickness.

In this specification, they are not clearly distinguished. Therefore, a “film” in this specification may include a “sheet”.

In this specification, term “omitted” affixed to a term expressing a shape means that the shape include partially changed shapes, such as a chamfered shape obtained by rounding the corners of the shape, a shape in which a part is missing (e.g., a part is cut out), and a shape with an arbitrary additional small shape added thereto.

In this specification, a “glass plate” refers to an un-tempered glass unless otherwise specified.

In this specification, the “surface of a glass plate” refers to a major surface having a large area other than the end surfaces (also referred to as sides) of the glass plate unless otherwise specified.

In this specification, “up and down”, “left and right”, “lengthwise and crosswise”, and “inside and outside” (or “inner and outer”) are “up and down”, “left and right”, “lengthwise and crosswise”, and “inside and outside” as viewed from the inside of the vehicle in the state in which the windshield for vehicle is mounted in the vehicle (in the state in which the windshield for vehicle is actually used) unless otherwise specified.

In this specification, when a symbol “-” (or “to”), which indicates a numerical range, is used, it means that a numerical value in front of the symbol and that behind the symbol are included as a lower limit value and an upper limit value, respectively, in the range.

Embodiments according to the present disclosure will be described hereinafter.

[Windshield for Vehicle]

The present disclosure relates to a windshield for vehicle in which a first glass plate and a second glass plate are bonded together with an intermediate film interposed therebetween.

One of the first and second glass plates is an exterior-side glass plate (also referred to as an outer glass plate) and the other glass plate is an interior-side glass plate (also referred to as an inner glass plate).

The type of the glass plate that is used as the material for the laminated glass is not limited to any particular types, and examples thereof include soda-lime glass, borosilicate glass, aluminosilicate glass, lithium-silicate glass, quartz glass, sapphire glass, and non-alkali glass.

The thickness of the laminated glass is not limited to any particular values, but is preferably 2 to 6 mm when it is used for a windshield for vehicle.

The thicknesses of the inner glass plate and the outer glass plate may be equal to each other or different from each other. The thickness of the inner glass plate is preferably 0.3 to 2.3 mm. When the thickness of the inner glass plate is 0.3 mm or larger, the handling property becomes satisfactory. Further, when it is 2.3 mm or smaller, it is possible to reduce the mass of the glass. The thickness of the outer glass plate is preferably 1.0 to 3.0 mm. When the thickness of the outer glass plate is 1.0 mm or larger, the strength such as the tolerance to stone chips is sufficient. Further, when it is 3.0 mm or smaller, the mass of the laminated glass is not too large, which is preferred in terms of the fuel efficiency of the vehicle. It is preferable that the thicknesses of the outer glass plate and the inner glass plate both be 1.8 mm or smaller, because such thicknesses make it possible to achieve a laminated glass reduced in weight and having an improved sound insulating property.

The windshield for vehicle may have, when it is mounted on a vehicle, a curved shape so that it is convex on the exterior side. When the windshield for vehicle is a laminated glass, both the inner glass plate and outer glass plate may have a curved shape so that they are convex on the exterior side. The windshield for vehicle may have a single curved shape, i.e., a shape that curved in only one of the left/right direction and the up/down direction, or may have a double curved shape, i.e., a shape that is curved in both the left/right direction and the up/down direction. The radius of the curvature of the windshield for vehicle may be 2,000 to 11,000 mm. The radii of the curvatures of the windshield for vehicle in the left/right and up/down directions may be equal to each other or different from each other. For bending the windshield for vehicle into a desired shape, gravity forming, press forming, roller forming, or the like is used.

The laminated glass may include, in at least a part of its surface, a functional film having a function such as a water repellent function, a low reflection function, a low emission function, an ultraviolet-light blocking function, an infrared-light blocking function, and a coloring function.

The laminated glass may include, in at least a part of the inside thereof, a functional film having a function such as a low reflection function, a low emission function, an ultraviolet-light blocking function, an infrared-light blocking function, and a coloring function. At least a part of an intermediate film of the laminated glass may have a function such as an ultraviolet-light blocking function, an infrared-light blocking function, and a coloring function.

The intermediate film of the laminated glass may be a single layer film or a laminated film.

In the windshield for vehicle according to the present disclosure, the laminated glass includes a first glass plate, a conductor that is formed on the interior surface of the first glass plate, is made of a material containing silver and glass frit, and includes a terminal joint portion to which a terminal is joined, and a glass plate with a terminal, including the terminal that is joined to the terminal joint portion of the conductor through lead-free solder.

In this specification, the “terminal joint portion” of the conductor refers to a part of the conductor directly below the lead-free solder.

In the glass plate with the terminal, the above-described conductor includes or is electrically connected to an electric function portion. Examples of the electric function portion include at least one electric heating line, an electric heating layer, an antenna, a dimming layer, a light-emitting element, and a combination thereof. Examples of the light-emitting element include an LED (Light Emitting Diode) and an OLED (Organic Light Emitting Diode).

It is possible to remove condensation, frost, snow, ice or the like and preventing them from being formed or adhering to the windshield or the like by at least one electric heating line or electric heating layer. At least one electric heating line or electric heating layer can be used to, for example, prevent condensation from being formed in any part of the windshield; prevent condensation from being formed in the sensing area of an optical apparatus including an optical device such as a camera and a radar; and prevent wipers and the like from being frozen. The electric function portion can be manufactured by a known method.

In a glass plate with a terminal, the above-described conductor includes a feeding portion for feeding electricity to the electric function portion. The feeding portion can include a pair of feeding electrodes (also referred to as a pair of busbars), and each of the feeding electrodes can include a terminal joint portion.

For example, one of the feeding electrodes is a positive electrode and connected to a power supply or a signal source provided inside the vehicle through a feeding member, and the other feeding electrode is a negative electrode and connected to the vehicle body (the ground) through a feeding member. Note that only one positive feeding electrode may be provided or a plurality of positive feeding electrodes may be provided. Further, only one negative feeding electrode may be provided or a plurality of negative feeding electrodes may be provided.

When a conductor is connected to the electric function portion, the conductor and the electric function portion may be formed on the same glass surface or on different glass surfaces.

The conductor including the terminal joint portion is formed by applying a silver-containing paste containing a silver powder and glass frit on a glass plate and firing the silver-containing paste.

A feeding member composed of a round lead or foil lead can be fixed to the terminal. The term “lead” in this specification includes a coated lead in which at least one lead is coated with an insulating material. A coated lead is preferred as the feeding member.

Examples of specific forms of the feeding member include a harness and a cable. The round lead is, for example, a wire harness or the like. Examples of the foil lead include a flat harness and a flexible printed circuit board or the like.

The feeding member includes a conductor-exposed portion, and the terminal is fixed to this conductor-exposed portion. The material of the conductor-exposed portion is not limited to any particular materials, and examples thereof include Cu, Al, Ag, Au, Ti, Sn, Zn, alloys thereof, and combinations thereof. The conductor-exposed portion may be one that is obtained by plating the surface of a main metal with another metal. The conductor-exposed portion may include a thin oxide film on the surface thereof.

Lead-free solder is solder that contains little or no lead, and known lead-free solder can be used. The content of lead in the lead-free solder is 500 ppm or less. Examples of the lead-free solder include: SnAg-based solder containing Sn and Ag; SnAgCu-based solder containing Sn, Ag and Cu; SnZnBi-based solder containing Sn, Zn and Bi; SnCu-based solder containing Sn and Cu; SnAgInBi-based solder containing Sn, Ag, In and Bi; and SnZnAl-based solder containing Sn, Zn, and Al.

In view of environmental tolerance, lead-free solder such as SnAg-based solder and SnAgCu-based solder are preferred.

The melting point of lead-free solder such as SnAg-based solder and SnAgCu-based solder is higher than that of leaded solder, and is, for example, about 220° C. When lead-free solder such as SnAg-based solder or SnAgCu-based solder is used, the solder joining temperature is, for example, about 300° C. The present disclosure is particularly effective when lead-free solder such as SnAg-based solder or SnAgCu-based solder having a high melting point is used.

Preferred embodiments of lead-free solder such as SnAg-based solder and SnAgCu-based solder will be described hereinafter.

The content of Sn in lead-free solder such as SnAg-based solder or SnAgCu-based solder is not limited to any particular values, and is preferably 95 mass % or more, more preferably 95 to 98.5 mass %, and particularly preferably 96 to 98 mass %. When the content of Sn is 95 mass % or more (the content of Ag is 5 mass % or less), the melting point of the lead-free solder can be relatively lowered, so that the solder joining temperature can be relatively lowered and the temperature rise of the glass plate can be relatively reduced. As a result, it is possible to suppress the residual stress occurring in the glass plate and thereby to prevent cracks from occurring in the glass plate which would otherwise occur due to the residual stress.

In general, when Sn-based lead-free solder containing no Ag is used, because of the high compatibility of Sn contained in the lead-free solder with Ag contained in the conductor, so-called “silver dissolving”, in which Ag contained in the terminal joint portion of the conductor dissolves into the lead-free solder containing Sn, tends to occur. In this case, there is a risk that the terminal joint portion may be discolored due to alteration, thinning, or the like, resulting in poor appearance.

By using lead-free solder containing Sn and Ag, it is possible to suppress the dissolution of Ag contained in the terminal joint portion of the conductor into the lead-free solder because Sn in the lead-free solder has already formed a compound(s) with Ag. Therefore, it is possible to prevent the terminal joint portion from being discolored and thereby to prevent its appearance from being impaired which would otherwise be caused by the discoloration.

The content of Ag in the lead-free solder is preferably 1.5 to 5 mass % and more preferably 2 to 4 mass %. When the content of Ag is 1.5 mass % or more, the dissolution of Ag contained in the terminal joint portion of the conductor into the lead-free solder can be effectively suppressed, and a satisfactory bonding strength can be achieved. When the content of Ag is 5 mass % or smaller, the cost of the material of the lead-free solder can be kept low and the melting point of the lead-free solder can be kept relatively low.

The lead-free solder may contain Cu as a metallic element other than Sn and Ag. The content of Cu in the lead-free solder is not limited to any particular values, and is preferably 1 mass % or smaller and more preferably 0.5 mass % or smaller.

Examples of the composition of the SnAg-based lead-free solder include Sn: 98 mass % and Ag: 2 mass %. Examples of the composition of the SnAgCu-based lead-free solder include Sn: 96.5 mass %, Ag: 3.0 mass %, and Cu: 0.5 mass %.

As described above in the “BACKGROUND” section, in general, the melting point of lead-free solder is higher than that of leaded solder, and is, for example, about 220° C., so it is necessary to perform solder joining at a higher temperature (for example, about 300° C.). In a glass plate with a conductor, when a conductor and a terminal are joined to each other by lead-free solder, the glass plate is locally heated to a high temperature and the temperature locally decreases from the high temperature to a normal temperature. When the temperature decreases, due to the difference between the thermal expansion coefficient of the glass plate and that of the lead-free solder, a difference occurs between the amount of the thermal shrinkage of the glass plate and that of the lead-free solder, thus causing a stress (specifically, a tensile stress) in the glass plate with the conductor. Further, in some cases, this stress remains even after the temperature has decreased. This residual stress may cause cracks in the glass plate after the window glass is manufactured. Further, since lead-free solder does not contain lead, which has a low elastic modulus, it has a higher elastic modulus than that of the leaded solder and is less likely to deform than leaded solder is. Therefore, a residual stress that has occurred in the glass plate with the conductor is less likely to be reduced. For these reasons, when a conductor and a terminal are joined to each other by lead-free solder, a problem that a residual stress occurs in the glass plate after the joining and cracks may occur after the manufacturing due to the residual stress could occur.

In the windshield for vehicle according to the present disclosure, the glass plate with the terminal includes the inorganic thin film between the first glass plate and the terminal joint portion, the inorganic thin film including at least one metal compound layer, having an overall thickness of 1,000 nm or smaller, and having a single-layer structure or a laminated structure, and at least the outermost surface of the inorganic thin film having an insulating property. In other words, in the conductor included in the glass plate with the terminal, at least the terminal joint portion is formed on the above-described inorganic thin film formed on the first glass plate. According to the research of the inventors of the present application, it has been found that in the above-described structure, the presence of the inorganic thin film can reinforce the terminal joint portion and increase the breaking strength of the first glass plate to which the terminal has not been attached yet or has already been attached.

Regarding the insulating property of the outermost surface of the inorganic thin film, its surface resistivity can be used as an indicator. When the surface resistivity of the outermost surface of the inorganic thin film is 1.0×10¹²Ω/□ or higher, the outermost surface of the inorganic thin film is regarded as insulative. The surface resistivity of the outermost surface of the inorganic thin film is, for example, no lower than 1.0×10¹²Ω/□ and lower than 1.0×10¹⁶Ω/□.

The inorganic thin film can be a vapor deposition film.

The inorganic thin film can include (i.e., contain) at least one metal compound layer.

The inorganic thin film preferably includes at least one insulating metal compound layer. When the inorganic thin film has a laminated structure, it is preferred that at least the outermost surface layer of the inorganic thin film is an insulating metal compound layer.

The inorganic thin film can include at least one insulating metal compound layer described above and at least one conductor layer. In this case, it is preferred that at least the outermost surface layer of the inorganic thin film is an insulating metal compound layer.

The inorganic thin film can be a functional film having a low reflection function, a low emission function, a water repellent function, an electric heating function, an antifogging function, an antifouling function, an infrared-light blocking function, an ultraviolet-light blocking function, a p-polarized-light reflection function, or a combination thereof or the like. A known functional film can be used as the aforementioned functional film.

Note that in this specification, the fact that “the inorganic thin film is a functional film” means that a functional film can be used as the inorganic thin film, and that the inorganic thin film does not necessarily have to have any of the above-described functions. Since the terminal joint portion is formed on the inorganic thin film, the inorganic thin film may not have any of the above-described functions. The purpose of the inorganic thin film formed between the first glass plate and the terminal joint portion is to reinforce the terminal joint portion and is not to provide a function.

Note that it is well known that in a windshield for vehicle, the above-described functional film is formed by a vapor deposition method. However, the functional film is usually unnecessary inside the formation area of a light-shielding layer, and in some cases, the appearance may be impaired when a light-shielding layer is formed on the formed functional film. Therefore, in the related art, it is common knowledge to those skilled in the art that no functional film is formed in the formation area of a light-shielding layer (also referred to as a light-shielding area). In other words, a functional film is formed only in the non-formation area of a light-shielding layer (also referred to as a non-light-shielding area).

When a functional film is formed in the non-light-shielding area of the first glass plate of the laminated glass, this functional film may be formed as an inorganic thin film for reinforcing the terminal joint portion at least in the formation area of the terminal joint portion of the light-shielding area in the same process. In this case, the inorganic thin film can be formed at low cost without increasing the number of processes.

If necessary, the glass plate with the terminal can include a first light-shielding layer on the interior surface of the first glass plate.

However, the terminal joint portion is preferably formed directly above the inorganic thin film. In other words, it is preferred that in the glass plate with the terminal, the first light-shielding layer is not provided between the inorganic thin film and the terminal joint portion.

Further, the glass plate with the terminal preferably does not include the first light-shielding layer between the first glass plate and the inorganic thin film at least inside the formation area of the terminal joint portion.

According to the research of the inventors of the present application, it has been found that in a conductor containing silver and glass frit, the glass frit component is densely present on or near the surface of the conductor. In particular, it has been found that when a conductor is formed on a light-shielding layer, the glass frit component is present more densely on or near the surface of conductor. It is inferred that these facts are due to the fact that a part of the glass frit component contained in the material for forming the conductor and the material for forming the light-shielding layer moves toward the surface layer when the materials are fired.

In general, the wettability of lead-free solder to the glass frit component is low. It is presumed that when the glass frit component is densely present on or near the surface of the conductor, the bonding strength of lead-free solder to the conductor is lowered, so that solder fillet having satisfactory shapes are less likely to be formed and hence the breaking strength of the glass plate to which the terminals have already been attached is lowered.

In the above-described structure, since no glass frit component derived from the material for forming the light-shielding layer is present in the terminal joint portion, it is possible, for the terminal joint portion formed on the light-shielding layer, to reduce the amount of the glass frit component present on or near the surface of the terminal joint portion. It is presumed that: as a result, the wettability of lead-free solder to the terminal joint portion can be improved; the bonding strength of lead-free solder to the terminal joint portion can be improved; and solder fillet having satisfactory shapes can be formed. The effect for reinforcing the terminal joint portion obtained by the inorganic thin film, combined with the effect for reducing the glass frit component on or near the surface of the terminal joint portion, can effectively enhance the breaking strength of the glass plate with the terminal (the first glass plate to which the terminal has already been attached).

Note that in the technology disclosed in the present disclosure, since effect for reinforcing the terminal joint portion by the inorganic thin film is obtained, the glass plate with the terminal may include a first light-shielding layer between the inorganic thin film and the terminal joint portion.

It is preferred that the feeding portion of the conductor included in the glass plate with the terminal is designed so that it is not visible to people outside the vehicle.

It is preferred that: the glass plate with the terminal does not include the first light-shielding layer between the first glass plate and the inorganic thin film at least inside the formation area of the terminal joint portion; in a structure in which the terminal joint portion is formed directly above the inorganic thin film, the first light-shielding layer is formed between the interior surface of the first glass plate and at least a part of the conductor other than the terminal joint portion; and a second light-shielding layer covering the terminal joint portion of the conductor is formed, in a plan view, on the exterior surface of the first glass plate and at least one of two surfaces of the second glass plate. By the above-described structure, the feeding portion included in the glass plate with the terminal can be designed so that it is not visible to people outside the vehicle.

The light-shielding layer can be formed by a known method, for example, by applying a ceramic paste containing a black pigment and glass frit to a predetermined area on the surface of the glass plate, and firing the applied ceramic paste. The thickness of the light-shielding layer is not limited to any particular values, and is, for example, 5 to 20 μm.

For the conductor the glass frit for the light-shielding layer, known conductor and glass frit can be used. As the metallic element, any of those containing Na, Al, Si, P, Zn, Ba, Bi and the like can be used.

A windshield for vehicle according to the present disclosure can be manufactured, for example, by the following manufacturing method.

The method for manufacturing a windshield for vehicle according to the present disclosure can include:
forming an inorganic thin film in at least a formation area of a terminal joint portion on the interior surface of a first glass plate by a vapor deposition method, the inorganic thin film including at least one metal compound layer, having an overall thickness of 1,000 nm or smaller, and having a single-layer structure or a laminated structure, and at least the outermost surface of the inorganic thin film having an insulating property (S11);
applying a silver-containing paste to the interior surface of the first glass plate, on which the inorganic thin film has been formed, the silver-containing paste containing silver and glass frit as a material for the conductor (S13);
forming the conductor by firing the first glass plate, to which the material for the conductor has been applied, and thereby obtaining a glass plate with a conductor (S14);
bonding the glass plate with the conductor and the second glass plate together with the intermediate film interposed therebetween (S15); and
joining the terminal to the terminal joint portion included in the conductor through lead-free solder (S16).

The windshield for vehicle can be regarded as one in which the terminal joint portion is formed directly above the inorganic thin film, and the first light-shielding layer is formed between the interior surface of the first glass plate and at least a part of the conductor other than the terminal joint portion.

In this case, the method for manufacturing a windshield for vehicle according to the present disclosure further includes, between the steps (S11) and (S13), applying a ceramic paste containing a black pigment and glass frit, as a material for the first light-shielding layer, to the interior surface of the first glass plate, on which the inorganic thin film has been formed (S12), and
in the step (S14), the first light-shielding layer and the conductor are formed by firing the first glass plate, to which the material for the first light-shielding layer and the material for the conductor have been applied, and the glass plate with the conductor can thereby be obtained.

### First Embodiment

A structure of a windshield for vehicle according to a first embodiment of the present disclosure will be described with reference to the drawings.

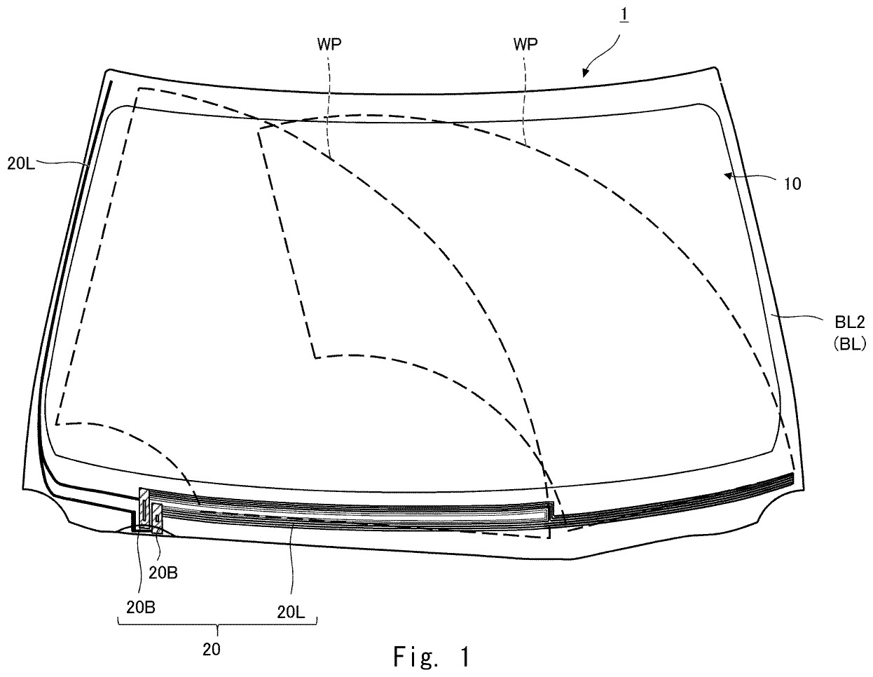

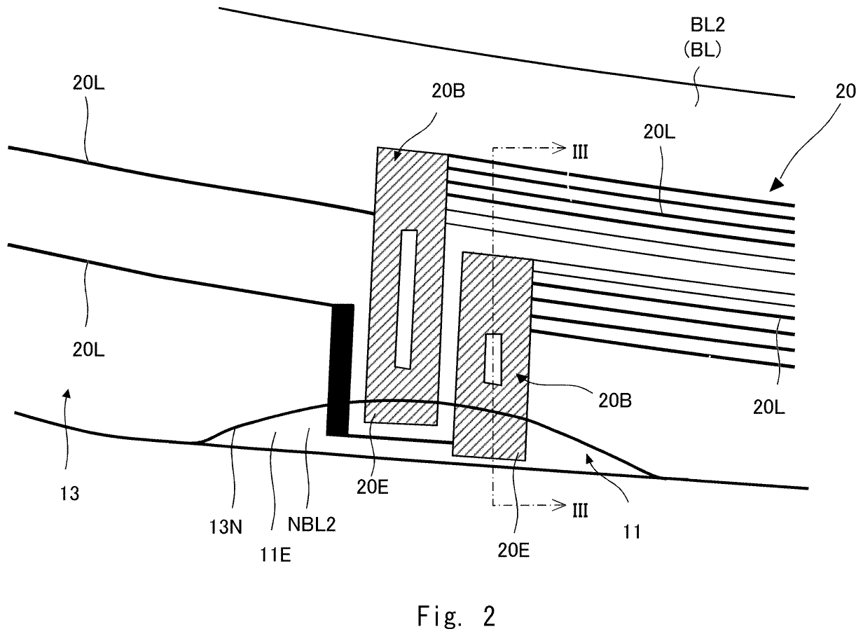

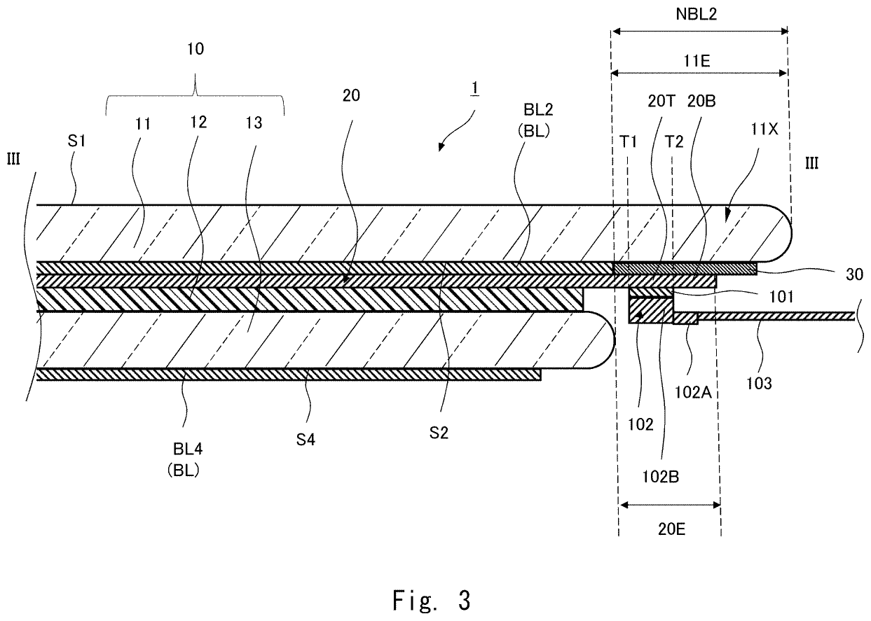

FIG. 1 is an overall plan view of a windshield for vehicle according to this embodiment. FIG. 2 is a partially enlarged plan view of FIG. 1. FIGS. 1 and 2 show a state before terminals are joined, in which the front side of the drawing is the interior side of the vehicle and the rear side thereof is the exterior side thereof. FIG. 3 is a cross-sectional diagram taken along a line in FIG. 2. In FIG. 3, the upper side of the drawing is the exterior side of the vehicle and the lower side is the interior side thereof. Regarding these figures, plan views and partially enlarged plan views are all perspective views. These drawings are all schematic diagrams, and the scales of components are changed from those of the actual ones on a drawing-by-drawing basis for facilitating the visual recognition of them.

The planar shape of the windshield for vehicle 1 can be designed as desired, and is, for example, a roughly trapezoidal plate-like shape in a plan view in which the plate is curved over the entire the length as shown in FIG. 1.

As shown in FIG. 3, the windshield for vehicle 1 according to this embodiment includes a laminated glass 10 in which an outer glass plate 11 (a glass plate on the exterior side of the vehicle, a first glass plate in this embodiment) and an inner glass plate 13 (a glass plate on the interior side of the vehicle, a second glass plate in this embodiment) are bonded together with an intermediate film 12 interposed therebetween.

In this embodiment, the laminated glass 10 includes a glass plate with a terminal 11X including the outer glass plate 11, a conductor 20 that is formed on the interior surface S2 of the outer glass plate 11 (the surface of the outer glass plate 11 on the intermediate film 12 side), is made of a material containing silver and glass frit, and includes a terminal joint portion 20T to which a terminal 102 is joined, and the terminal 102 that is joined the terminal joint portion 20T of the conductor 20 through lead-free solder 101.

As shown in FIG. 1, the windshield for vehicle 1 according to this embodiment includes at least one light-shielding layer BL in the peripheral area. The peripheral area, where the at least one light-shielding layer BL is formed, is referred to as a light-shielding area of the laminated glass 10, and an area inside the light-shielding area (i.e., an area surrounded by the light-shielding area) is referred to as a non-light-shielding area. The number of light-shielding layers BL, the glass surface where the light-shielding layer BL is formed, and the formation area of the light-shielding layer BL can be designed as desired.

In the example shown in the drawing, the windshield for vehicle 1 can include, as at least one light-shielding layer BL, a light-shielding layer BL2 and, if necessary, a light-shielding layer BL4. Specifically, as shown in FIG. 3, the light-shielding layer BL2 is formed in a predetermined area on the interior surface S2 of the glass plate 11 (the surface of the glass plate 11 on the intermediate film 12 side). If necessary, the light-shielding layer BL4 can be formed in a predetermined area on the interior surface S4 of the inner glass plate 13 (the surface on the side opposite to the intermediate film 12 side).

In this embodiment, the conductor 20 has a function of melting frost, snow, ice and the like attached to the wipers and preventing the wipers from being frozen. In FIG. 1, an area indicated by dashed lines indicated by a symbol WP is the area over which the wipers move.

As shown in FIGS. 1 and 2, the conductor 20 includes an electric function portion composed of at least one electric heating line 20L or electric heating layer. Note that an example in which the conductor 20 includes a plurality of electric heating lines 20L is shown in the drawing. The conductor 20 may further include a feeding portion including a pair of feeding electrodes (a pair of busbars) 20B. One of the pair of feeding electrodes (the pair of busbars) 20B is a positive electrode and the other feeding electrode is a negative electrode. The conductor can be formed, for example, at the lower end and/or at least one of the side edges of the windshield for vehicle 1. The structure, pattern, and formation area of the conductor 20 can be designed as desired.

As shown in FIG. 2, the inner glass plate 13 include a cut-out portion 13N at the lower end. Owing to this cut-out portion 13N, the glass plate with the terminal 11X includes an exposed portion 11E that is not covered by the inner glass plate 13, which is opposed to the outer glass plate 11 with the intermediate film 12 interposed therebetween. In this embodiment, the conductor 20 is formed on the intermediate film 12 side of the glass plate with the terminal 11X. Each of the pair of feeding electrodes (the pair of busbars) 20B is at least partially formed in the exposed portion 11E of the glass plate with the terminal 11X and hence is exposed without being covered by the inner glass plate 13.

As shown in FIGS. 2 and 3, in each of the pair of feeding electrode (the pair of busbars) 20B, the exposed portion 20E of the feeding electrode 20B includes the terminal joint portion 20T, and the terminal 102 is joined to the terminal joint portion 20T with the lead-free solder 101 interposed therebetween. A feeding member 103 composed of a round lead or foil lead is fixed to the terminal 102.

The terminal joint portion 20T of the conductor 20 is a part thereof located directly below the lead-free solder 101. In the drawings, the formation area of the terminal joint portion 20T is an area interposed between two broken lines T1 and T2. Note that the position of the terminal joint portion 20T of the conductor 20 is not clearly defined in advance. In the feeding electrode 20B, the part that is located directly below the lead-free solder 101 after the terminal 102 is joined thereto through the lead-free solder 101 is the terminal joint portion 20T.

As shown in FIG. 3, the glass plate with the terminal 11X includes the inorganic thin film 30 between the outer glass plate 11 and the terminal joint portion 20T, the inorganic thin film 30 including at least one metal compound layer, having an overall thickness of 1,000 nm or smaller, and having a single-layer structure or a laminated structure, and at least the outermost surface of the inorganic thin film 30 having an insulating property.

In the example shown in the drawing, the inorganic thin film 30 is formed on the exposed portion 20E of the feeding electrode 20B so as to include at least the formation area of the terminal joint portion 20T.

Note that in FIG. 3, the formation areas of the exposed portions 11E and 20E are indicated by double-headed arrows for facilitating the visual recognition of them.

In the above-described structure, the presence of the inorganic thin film 30 can enhance the breaking strength of the outer glass plate 11 to which the terminal has not been attached yet or has already been attached.

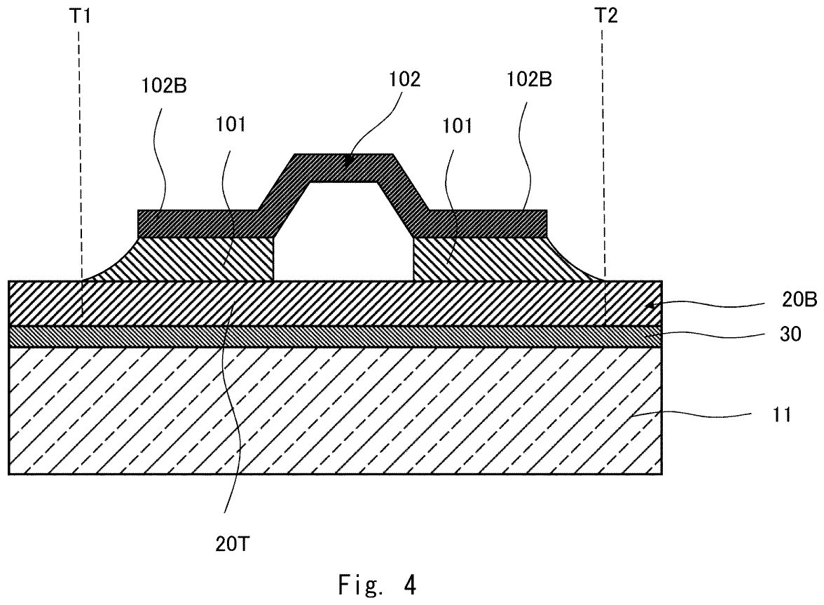

FIG. 4 is a partially enlarged cross-sectional diagram of the laminated structure of Terminal 102/Lead-Free Solder 101/Feeding Electrode 20B including Terminal Joining Portion 20T/Inorganic Thin Film 30/Outer Glass Plate 11 shown in FIG. 3 as viewed from the left side in FIG. 3. In this example, the laminated structure is shown upside down for facilitating the visual recognition thereof.

As the feeding member 103, a round lead or foil lead is preferred, and a round coated lead or foil coated lead is more preferred. A wire harness, a flat harness, or the like is preferred.

The tip of the feeding member 103 is a conductor-exposed portion, and the terminal 102 is fixed to this conductor-exposed portion.

As the terminal 102, a known crimp terminal (e.g., a crimp contact) is preferred. The crimp terminal is preferably one that includes a feeding member joint portion 102A that comes into contact with the tip (the conductor-exposed portion) of the feeding member 103 (see FIG. 3) and a solder joint portion 102B that comes into contact with the lead-free solder 101 (see FIGS. 3 and 4).

When a wire harness is used as the feeding member 103, the crimp terminal is preferably a crimp terminal composed of a feeding member joint portion 102A for swaging and fixing the tip (the conductor-exposed portion) of the wire harness, and a bridge-like portion including a solder joint portion 102B at each of both ends thereof as shown in FIGS. 3 and 4. The crimp terminal may be one that includes one solder joint portion 102B without including a bridge-like portion.

The terminal 102 is preferably a terminal made of metal. The metal of which the terminal is made is not limited to any particular metals, and examples thereof include: metals such as Cu, Fe, Cr, Ni and Zn; alloys containing at least one metallic element such as Cu, Fe, Cr, Ni and Zn; and combinations thereof. Examples of alloys include stainless steel (SUS) and brass. The terminal 102 may be one in which a surface treatment such as tin plating is performed on its surface in advance. At least a part of the terminal 102 may be coated with an insulating material. The thickness of the terminal 102 is not limited to any particular values, and is preferably 0.4 to 0.8 mm. In the case of the terminal 102 made of a single material, it can be manufactured, for example, by punching a metal plate (a pressing process using a die) and thereby obtaining a metal plate having a desired size, and bending it into a desired shape (a bending process).

For example, the terminal 102 (preferably a crimp terminal) is swaged and fixed to the tip (the conductor-exposed portion) of the feeding member 103, and this terminal 102 is joined to the terminal joint portion 20T included in the feeding electrode 20B through lead-free solder 101. Note that the tip (the conductor-exposed portion) of the feeding member 103 and the terminal 102 may be connected by soldering or by welding.

The inorganic thin film 30 can be a vapor deposition film. The vapor deposition film is a film formed by a known vapor deposition method. Examples of vapor deposition methods include a vacuum deposition method, a sputtering method, an ion plating method (an IP method), a laser ablation method, a chemical vapor deposition method (a CVD method), and a plasma chemical vapor deposition method (a plasma CVD method).

The inorganic thin film 30 can include at least one metal compound layer containing at least one metal compound selected from the group consisting of oxides, nitrides, and oxynitrides of at least one metal element selected from the group consisting of B, Al, Si, Ti, Cr, Ni, Zn, Ga, Y, Zr, Nb, In, Sn, Hf, Ta and W.

Examples of the aforementioned metal compound include metal oxides such as Al₂O₃, SiO₂, TiO₂, ZnO, Ga₂O₅, Y₂O₃, ZrO₂, Nb₂O₅, In₂O₃, ITO (Indium Tin Oxide), SnO₂, HfO₂, Ta₂O₅ and WO₃; metal nitrides such as AlN, SiNₓ and TiNₓ; metal oxynitrides such as AlON and SiON; and combinations thereof. The metal compound layer may contain at least one element other than the aforementioned elements and/or unavoidable impurities.

The metal compound layer may be, for example, one having a composition that is obtained by doping any of the aforementioned metal compounds with an arbitrary element.

The inorganic thin film 30 preferably contains at least one insulating metal compound layer containing at least one insulating metal compound selected from the group consisting of oxides, nitrides, oxynitrides of at least one metal element selected from the group consisting of B, Al, Si, Ti, Cr, Ni, Ga, Y, Zr, Nb, Hf, Ta and W. When the inorganic thin film 30 has a laminated structure, it is preferred that at least the outermost surface layer of the inorganic thin film 30 is the above-described insulating metal compound layer.

Examples of the aforementioned insulating metal compound include metal oxides such as Al₂O₃, SiO₂, TiO₂, Ga₂O₅, Y₂O₃, ZrO₂, Nb₂O₅, HfO₂, Ta₂O₅ and WO₃; metal nitrides such as AlN, SiNₓ and TiNₓ; metal oxynitrides such as AlON and SiON; and combinations thereof.

The insulating metal compound layer may contain at least one element other than the aforementioned elements and/or unavoidable impurities. The metal compound layer may be, for example, one having a composition that is obtained by doping any of the aforementioned insulating metal compounds with an arbitrary element.

The inorganic thin film 30 may include at least one insulating metal compound layer described above and at least one conductor layer containing at least one substance selected from the group consisting of metals and conductive metal compounds. In this case, it is preferred that at least the outermost surface layer of the inorganic thin film 30 is the above-described insulating metal compound layer.

Examples of metals include Ag, Au, Cu, Pd, Pt, Ti, Cr, Ni, Al, Zr, W, V, Rh, Ir, alloys thereof, and combinations thereof.

Examples of conductive metal compounds include ITO (Indium Tin Oxide), Ti-doped ZnO (TZO), F-doped SnO (FTO), Sb-doped SnO (ATO), Al-doped SnO, and combinations thereof.

The thicker the overall thickness of the inorganic thin film 30 is, the more the effect for reinforcing the terminal joint portion 20T tends to improve. However, when the overall thickness is large, the film formation time increases and the cost becomes higher. In view of the deposition time and the deposition cost, the overall thickness of the inorganic thin film 30 is 1,000 nm or smaller, preferably 500 nm or smaller, and more preferably 200 nm or smaller. The lower limit of the overall thickness of the inorganic thin film 30 is not limited to any particular values. However, in view of the effect for reinforcing the terminal joint portion 20T, the lower limit is preferably 100 nm and more preferably 150 nm.

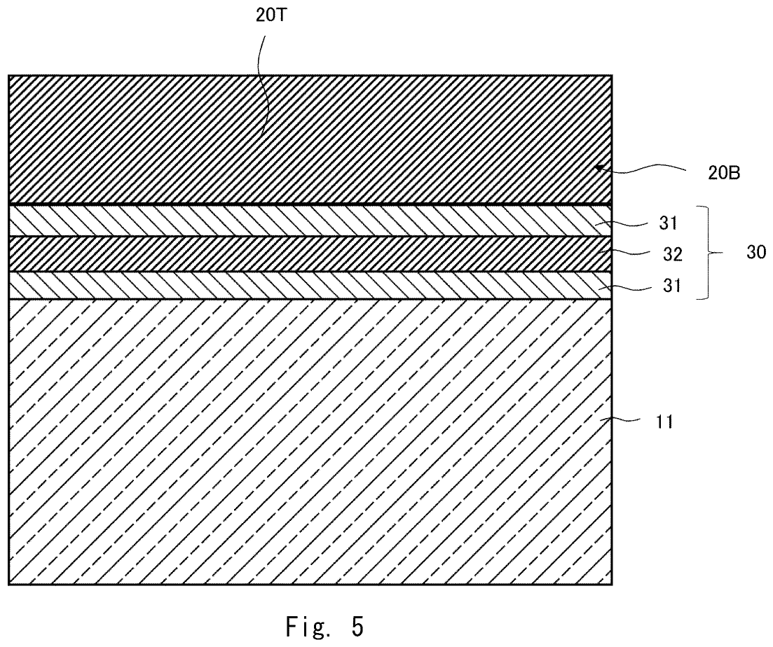

FIG. 5 shows an enlarged schematic cross-sectional diagram of the laminated structure of Feeding Electrode 20B/Inorganic Thin Film 30/Outer Glass Plate 11 including the terminal joint portion 20T shown in FIG. 4.

In the example shown in the drawing, the inorganic thin film 30 is composed of a plurality of insulating metal compound layers 31 and a conductor layer 32 interposed between the plurality of insulating metal compound layer 31. At least the outermost surface layer (the layer in contact with the terminal joint portion 20T) of the inorganic thin film 30 is the insulating metal compound layer 31.

The number of layers of the inorganic thin film 30 is one or more, and may be two or more or three or more. The maximum number of layers of the inorganic thin film 30 is not limited to any particular numbers and is, for example, five.

Unlike International Patent Publication No. WO2011/138600, in this embodiment, the feeding portion including a pair of feeding electrodes 20B is not used to feed electricity to the inorganic thin film 30, and the electric current flowing to the feeding portion including the pair of feeding electrodes 20B does not flow into the inorganic thin film 30. Even when the inorganic thin film 30 includes the conductor layer 32, the feeding portion including the pair of feeding electrodes 20B and the conductor layer 32 are insulated from each other.

The inorganic thin film 30 can be a functional film having a low reflection function, a low emission function, a water repellent function, an electric heating function, an antifogging function, an antifouling function, an infrared-light blocking function, an ultraviolet-light blocking function, a p-polarized-light reflection function, or a combination thereof or the like. In this case, a functional film may be formed in the non-light-shielding area of the laminated glass 10 on the interior surface S2 of the outer glass plate 11.

In other words, when an inorganic thin film is formed as a functional film in the non-light-shielding area of the laminated glass 10 on the interior surface S2 of the outer glass plate 11, this inorganic thin film can also be formed as the inorganic thin film 30 for reinforcing the terminal joint portion 20T in the area including the formation area of the terminal joint portion 20T. In this case, the inorganic thin film 30 can be formed in the same process as the process for the inorganic thin film formed as the functional film in the non-light-shielding area of the laminated glass 10.

As described above, the windshield for vehicle 1 according to this embodiment has at least one light-shielding layer BL in the peripheral area.

As shown in FIG. 1, in this embodiment, a light-shielding layer BL2 (a first light-shielding layer) is formed in the peripheral area on the interior surface S2 of the outer glass plate 11. However, there is an area where the light-shielding layer BL2 is not formed inside the light-shielding area of the laminated glass 10 on the interior surface S2 of the outer glass plate 11.

As shown in FIGS. 3 to 5, the terminal joint portion 20T is preferably formed directly above the inorganic thin film 30. In other words, the glass plate with the terminal 11X preferably does not include the light-shielding layer BL2 between the inorganic thin film 30 and the terminal joint portion 20T.

Further, the glass plate with the terminal 11X preferably does not include the light-shielding layer BL2 between the outer glass plate 11 and the inorganic thin film 30 at least inside the formation area of the terminal joint portion 20T.

In FIGS. 2 and 3, the symbol NBL2 indicates the non-formation area of the light-shielding layer BL2 including the formation area of the terminal joint portion 20T. Although an exposed portion 11E corresponds to the non-formation area NBL2 of the light-shielding layer BL2 in the example shown in the drawing, the non-formation area NBL2 of the light-shielding layer BL2 can be designed as desired within the range including the formation area of the terminal joint portion 20T.

Note that in practice, the overall thickness of the inorganic thin film 30 is very small relative to the thickness of the light-shielding layer BL2. However, in FIG. 3, the inorganic thin film 30 is shown with a relatively large thickness for facilitating the visual recognition thereof.

Further, although the inorganic thin film 30 and the light-shielding layer BL2 do not overlap each other and are adjacent to each other with no space therebetween in FIG. 3, the inorganic thin film 30 and the light-shielding layer BL2 may partially overlap each other. In the part where the inorganic thin film 30 and the light-shielding layer BL2 overlap each other, the light-shielding layer BL2 is disposed over the inorganic thin film 30. The inorganic thin film 30 and the light-shielding layer BL2 may be adjacent to each other with some space therebetween.

In this embodiment, the light-shielding layer BL2 is formed, on the interior surface S2 of the outer glass plate 11, in the area inside the light-shielding area other than the formation area of the terminal joint portion 20T. Further, most of the conductor 20, i.e., the part of the conductor 20 that includes the electric function portion composed of at least one electric heating line 20L or electric heating layer but does not include at least terminal joint portion 20T, is formed on this light-shielding layer BL2.

Further, the above-described structure, since no glass frit component derived from the material for forming the light-shielding layer is present in the terminal joint portion 20T, it is possible, for the terminal joint portion formed on the light-shielding layer, to reduce the amount of the glass frit component present on or near the surface of the terminal joint portion 20T. The effect for reinforcing the terminal joint portion 20T obtained by the inorganic thin film 30, combined with the effect for reducing the glass frit component on or near the surface of the terminal joint portion 20T, can effectively enhance the breaking strength of the glass plate with the terminal 11X.

Note that in the technology disclosed in the present disclosure, since the effect for reinforcing the terminal joint portion 20T by the inorganic thin film 30 is obtained, the glass plate with the terminal 11X may include the light-shielding layer BL2 between the inorganic thin film 30 and the terminal joint portion 20T.

Further, in this embodiment, as shown in FIG. 3, a light-shielding layer BL4 may be formed in the peripheral area on at least one of the surfaces of the inner glass plate 13. In the example shown in the drawing, the light-shielding layer BL4 is formed in the peripheral area on the interior surface S4 of the inner glass plate 13.

(Manufacturing Method)

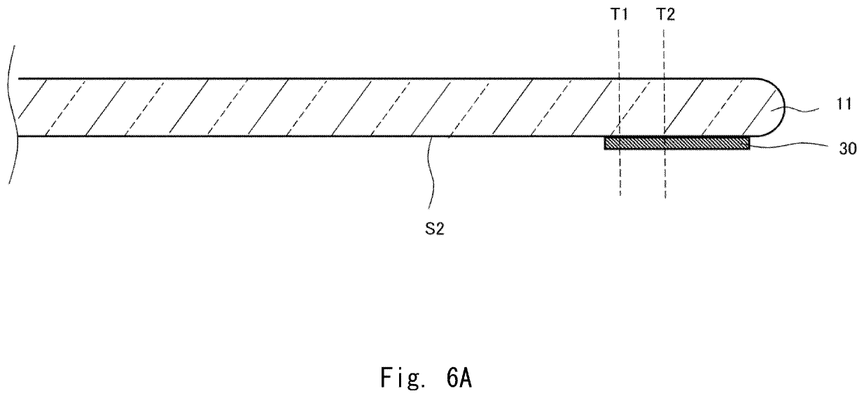

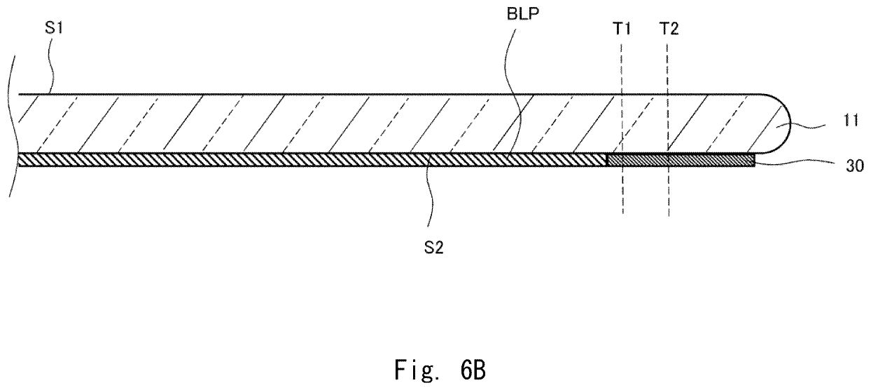

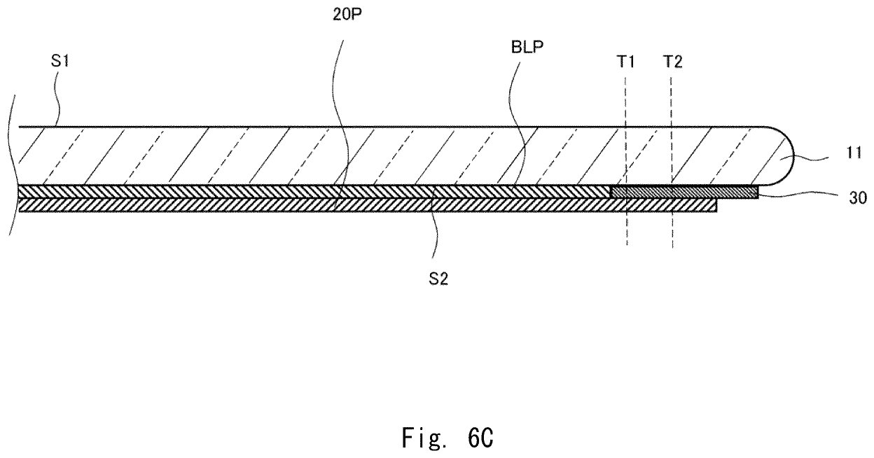

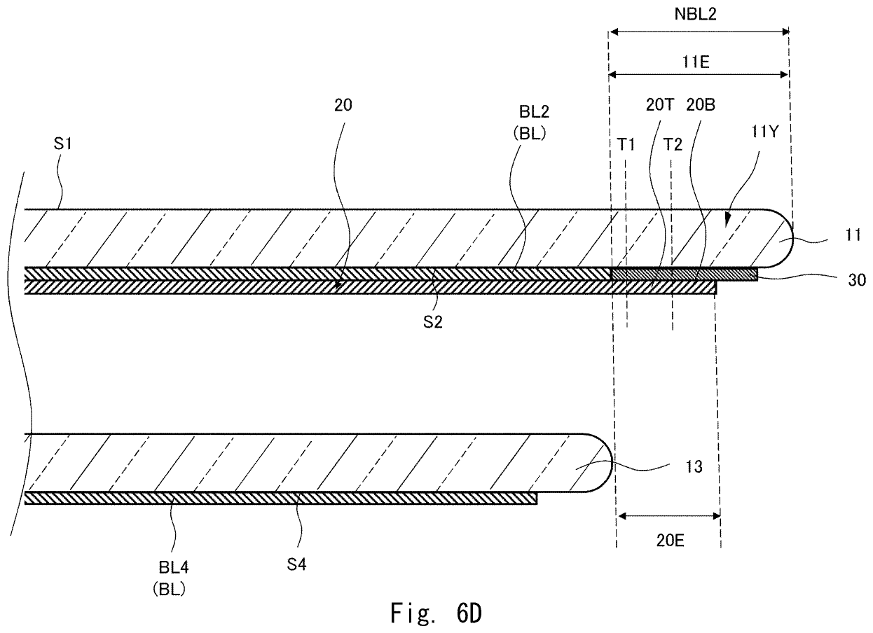

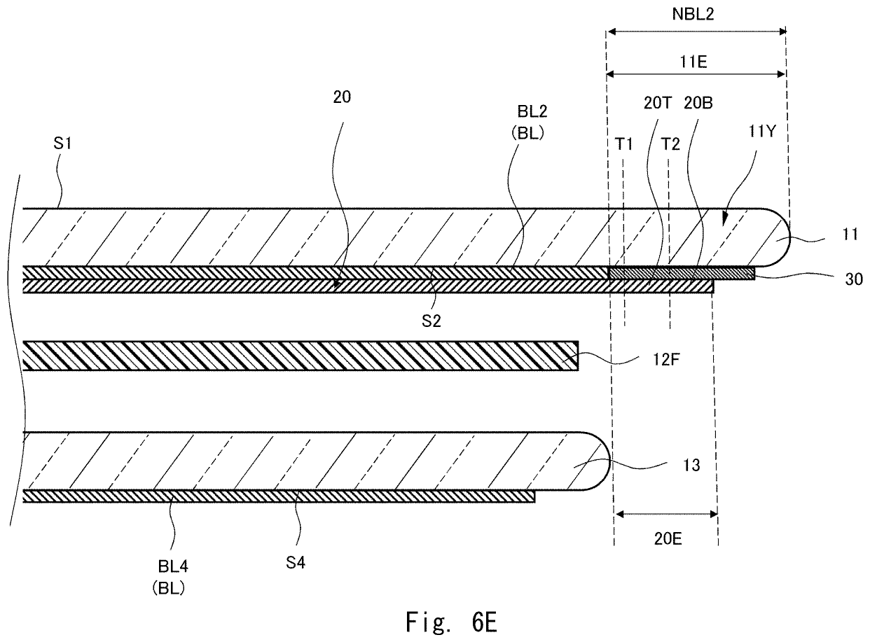

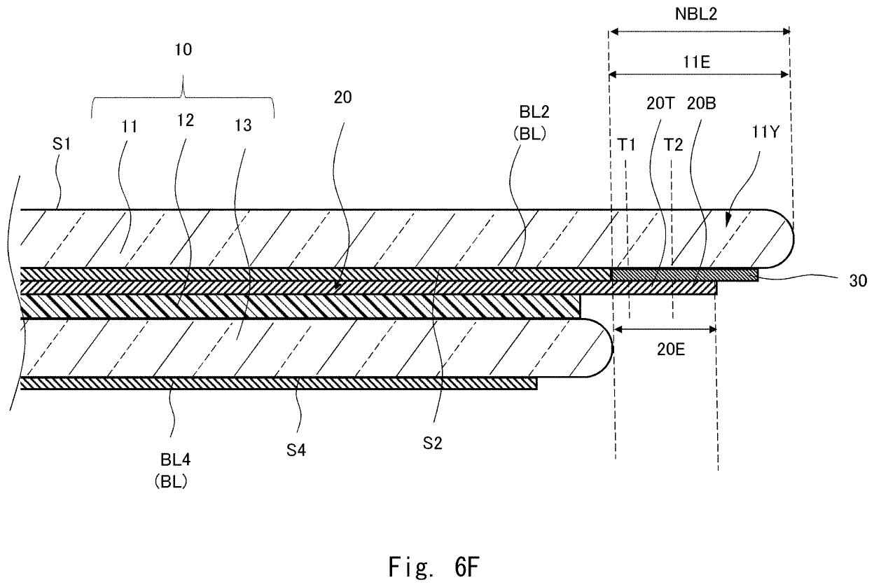

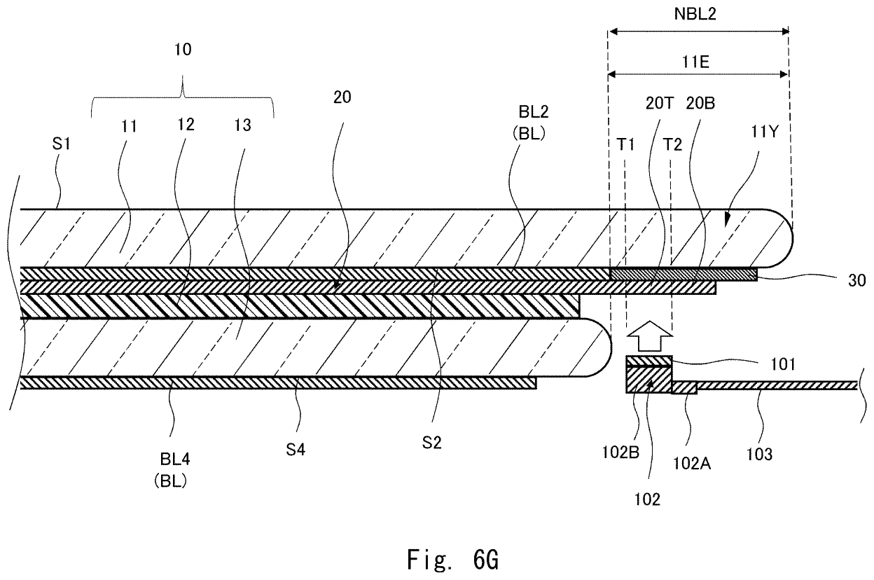

An example of a method for manufacturing a windshield for vehicle according to this embodiment will be described with reference to the drawings. FIGS. 6A to 6G are schematic cross-sectional diagrams corresponding to FIG. 3.

(Step (S11))

Firstly, as shown in FIG. 6A, in the formation area of at least a terminal joint portion 20T on an interior surface S2 of an outer glass plate 11 (a glass plate on the exterior side of the vehicle, a first glass plate in this embodiment), an inorganic thin film 30, which includes at least one metal compound layer, has an overall thickness of 1,000 nm or smaller, has a single-layer structure or a laminated structure, and of which at least the outermost surface has an insulating property, is formed by a known vapor deposition method.

(Step (S12))

Next, as shown in FIG. 6B, a ceramic paste layer BLP is formed by applying a ceramic paste containing a black pigment and glass frit, which is a material for a light-shielding layer BL2 (a first light-shielding layer in this embodiment), to a predetermined area on the interior surface S2 of the outer glass plate 11, on which the inorganic thin film 30 has been formed, other than the formation area of the terminal joint portion 20T, and drying the applied ceramic paste.

Further, if necessary, a ceramic paste layer BLP is also formed by applying a ceramic paste containing a black pigment and glass frit, which is a material for a light-shielding layer BL4, to a predetermined area on the interior surface S4 of the inner glass plate 13, and drying the applied ceramic paste.

The conditions for drying the ceramic paste can be designed as appropriate according to the composition of the paste, and are preferably, for example, 120 to 150° C. and about five minutes.

(Step (S13))

Next, as shown in FIG. 6C, a conductive paste layer 20P is formed by applying a silver-containing paste containing silver and glass frit, which is a material for a conductor 20, to the interior surface S2 of the outer glass plate 11, on which the inorganic thin film 30 has been formed, and drying the applied silver-containing paste. The conditions for drying the silver-containing paste can be designed as appropriate according to the composition of the paste, and are preferably, for example, 120 to 150° C. and about five minutes.

(Step (S14))

Next, the outer glass plate 11 and the inner glass plate 13, which have undergone the above-described steps, are heated simultaneously or individually to a temperature equal to or higher than their softening points (e.g., 700 to 800° C.), and each of the glass plates is bent into a desired shape. In this step, the ceramic paste layer BLP and the conductive paste layer 20P are simultaneously fired, so that a light-shielding layer BL2, if necessary, a light-shielding layer BL4, and a conductor 20 are formed. After the firing, each of the glass plates is slowly cooled.

After the above-described steps, as shown in FIG. 6D, a glass plate with a conductor 11Y and an inner glass plate 13, which may include the light-shielding layer BL4, are obtained.

(Step (S15))

Next, as shown in FIG. 6E, the glass plate with the conductor 11Y and the inner glass plate 13, which may include the light-shielding layer BL4, are bonded together with a resin film 12F made of a material for an intermediate film 12 interposed therebetween (a bonding step).

The resin of which the resin film 12F is formed is not limited to any particular resins. Examples of preferred resins include at least one resin selected from the group consisting of polyvinyl butyral (PVB), ethylene vinyl acetate copolymer (EVA), cycloolefin polymer (COP), polyurethane (PU), and ionomer resins. If necessary, the resin film 12F may contain at least one additive other than the resin. Examples of additives include colorants such as pigments. The resin film 12F may be transparent and colorless, or may be transparent and colored. The resin film 12F may have a single layer structure or a laminated structure composed of two or more layers.

The bonding can be carried out by thermocompression bonding. Examples of thermocompression bonding methods include: a method in which a temporary laminate obtained by stacking a plurality of members shown in FIG. 6E is placed in a bag made of rubber or the like and heated in a vacuum; a method in which a temporary laminate is pressurized and heated by using an automatic pressurizing and heating apparatus and an autoclave or the like; and a combination thereof.

The conditions for the thermocompression bonding, such as a temperature, a pressure, and a time, are not limited to any particular conditions and are designed according to the type of the resin film 12F and the temperature. The conditions for the thermocompression bonding may be any conditions as long as the resin film 12F can be softened, sufficiently pressurized, and the glass plate with the conductor 11Y and the inner glass plate 13, which may include the light-shielding layer BL4, can be sufficiently bonded to each other with a resin interposed therebetween. The thermocompression bonding may be carried out through a plurality of stages while changing the method or the conditions.

Note that the resin of which the resin film 12F is formed softens and spreads so as to fill the space between the glass plate with the conductor 11Y and the inner glass plate 13, which may include the light-shielding layer BL4.

After the above-described steps, a laminated glass 10 is obtained as shown in FIG. 6F.

(Step (S16))

Next, as shown in FIG. 6G, a terminal 102 is joined to the terminal joint portion 20T included in each feeding electrode 20B through lead-free solder 101. The surface of at least the terminal joint portion 20T of each feeding electrode 20B is preferably polished in advance by a known method using a sand eraser or the like. A feeding member 103, which is preferably composed of a round conductor or foil conductor, is fixed (preferably swaged and fixed) to the terminal 102 in advance by a known method. The solder joining is also shown in FIG. 4.

The solder joining can be performed by a known method, preferably by a method using a soldering iron or resistance heating.

When a soldering iron is used, the joining can be carried out, for example, as described hereinafter.

An appropriate amount (e.g., 0.05 to 0.10 g) of lead-free solder is applied to each solder joint portion of the terminal. This terminal is disposed on the terminal joint portion of the conductor. In this state, the tip of the soldering iron, of which the temperature is set to a temperature equal to or higher than the melting point of the lead-free solder, is pressed against the solder joint portion of the terminal, so that the lead-free solder is heated and melted. After that, the soldering iron is released from the terminal, and lead-free solder is solidified through natural cooling.

It is preferred that before the solder joining, a flux is applied to the surface of the lead-free solder that has not been melted yet and/or the surface of the solder joint portion of the terminal. The metal oxide film is melted by the effect of the flux, so that a satisfactory joint state can be achieved.

It is preferred that an appropriate amount of lead-free solder is put on the tip of the soldering iron and thereby is melted by the heat before the solder joining is performed. This solder is referred to as preparatory solder and can improve the heat conduction when the solder joining is performed.

In general, in order to join a conductor and solder in a satisfactory manner, it is necessary to form, at the joint interface between the conductor and the solder, an alloy layer containing an alloy of at least one metal element contained in the conductor and a plurality of metal elements contained in the solder. Therefore, the solder joining is performed by heating the solder to a temperature equal to or higher than its melting point.

The melting point of lead-free solder such as SnAg-based solder and SnAgCu-based solder is, for example, about 220° C., and in this case, the temperature of the solder joining is, for example, about 300° C.

Through the above-described processes, a windshield for vehicle 1 according to this embodiment is manufactured.

[Example of Change in Design According to First Embodiment]

In the first embodiment, an embodiment in which the conductor 20 includes an electric function portion composed of at least one electric heating line 20L or electric heating layer, and a feeding portion including a pair of feeding electrodes (a pair of busbars) 20B has been described. The conductor 20 may be configured so that it includes only the feeding portion without including an electric function portion, and this feeding portion is connected to an electric function portion that is not included in the conductor 20.

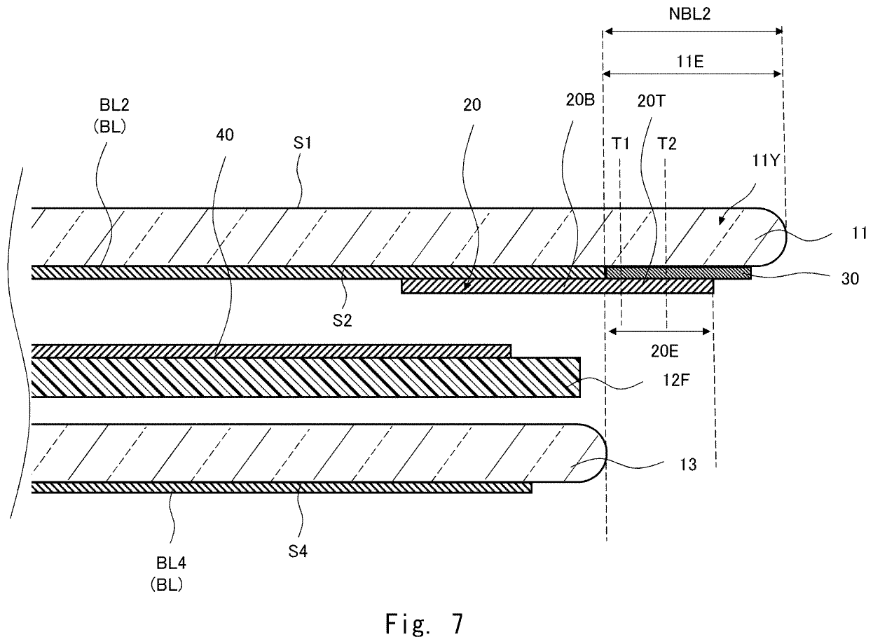

For example, as shown in FIG. 7, a conductor 40 including an electric function portion can be formed on a resin film 12F made of a material for an intermediate film 12. For example, the conductor 40 can include an electric function portion composed of at least one electric heating line or electric heating layer, and if necessary, can further include a feeding portion including a pair of feeding electrodes (a pair of busbars). In FIG. 7, the same reference numerals (or symbols) as those in the first embodiment are assigned to the same components/structures as those in the first embodiment, and descriptions thereof are omitted.

For example, on the resin film 12F, at least one metal wire (e.g., a tungsten wire or the like) can be disposed as the at least one electric heating line, and if necessary, a pair of metal foils (e.g., a pair of copper foils) can be disposed as the pair of feeding electrodes (the pair of busbars). Alternatively, a resin film (e.g., a polyvinyl butyral (PVB) film, an ethylene vinyl acetate copolymer (EVA) film, a polyethylene terephthalate (PET) film, or the like) in which at least one electric heating line and a pair of feeding electrodes are formed on its surface can be disposed on the resin film 12F.

After the glass plate with the conductor 11Y, the resin film 12F, and the inner glass plate 13 are bonded together, the electric function portion formed on the resin film 12F is connected to the conductor 20 composed solely of the feeding portion included in the glass plate with the conductor 11Y. The electric function portion formed on the resin film 12F may be connected to the conductor 20 composed solely of the feeding portion included in the glass plate with the conductor 11Y through the feeding portion formed on the resin film 12F.

Note that the structures, materials, formation methods, patterns, and formation areas of the conductor 40 including the electric function portion and, if necessary, the feeding portion, and the conductor 20 composed solely of the feeding portion included in the glass plate with the conductor 11Y, both of which are formed on the resin film 12F, can be designed as appropriate.

Even in this example of the change in the design, the inorganic thin film 30 which includes at least one metal compound layer, has an overall thickness of 1,000 nm or smaller, and has a single-layer structure or a laminated structure, and of which at least the outermost surface has an insulating property is formed between the outer glass plate 11 and the terminal joint portion 20T as in the first embodiment. The formation area of the inorganic thin film 30 is designed so as to include at least the formation area of the terminal joint portion 20T.

Even in this example of the change in the design, it is possible to manufacture a windshield for vehicle by bonding the glass plate with the conductor 11Y and the inner glass plate 13 with the intermediate film 12 interposed therebetween, and then joining a terminal to the terminal joint portion 20T included in the conductor 20 through lead-free solder as in the first embodiment.

### Second Embodiment

A configuration of a windshield for vehicle according to a second embodiment of the present disclosure will be described with reference to the drawings.

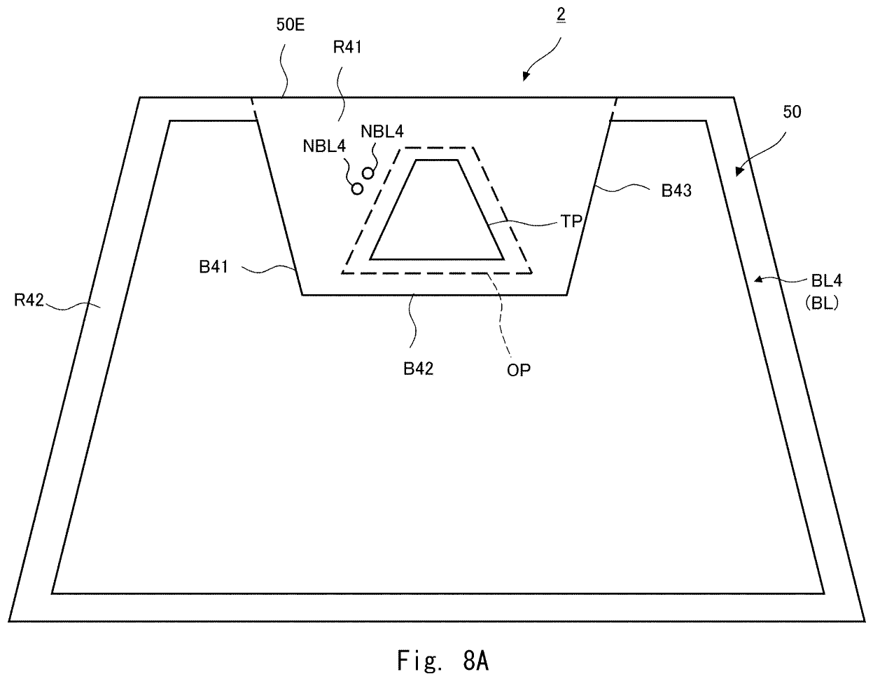

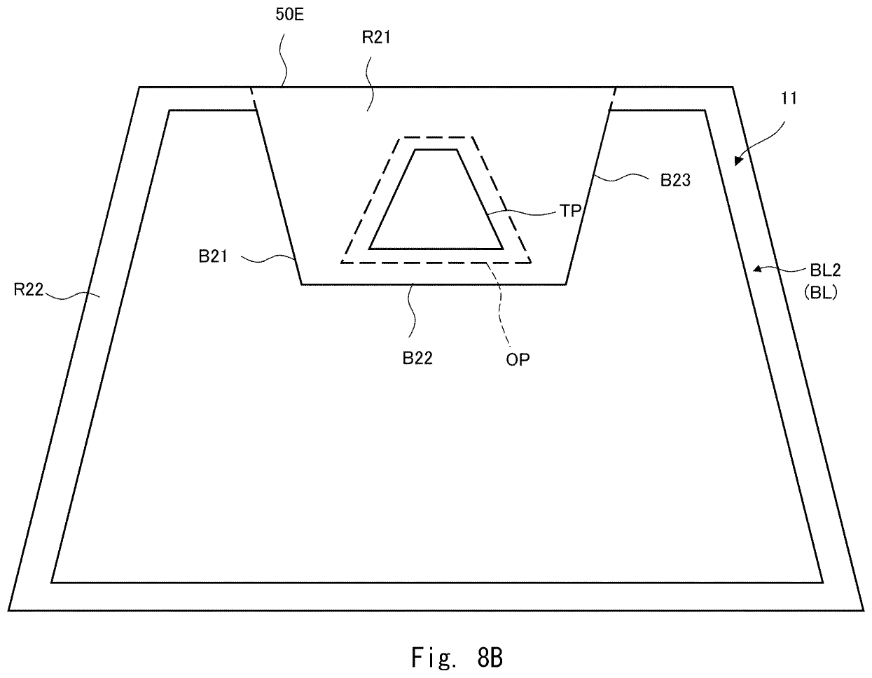

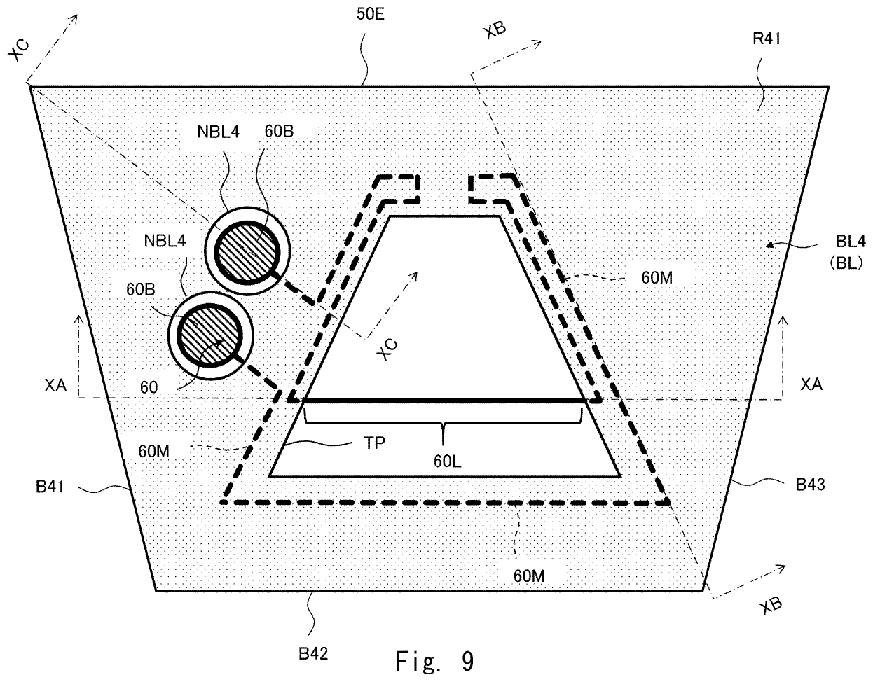

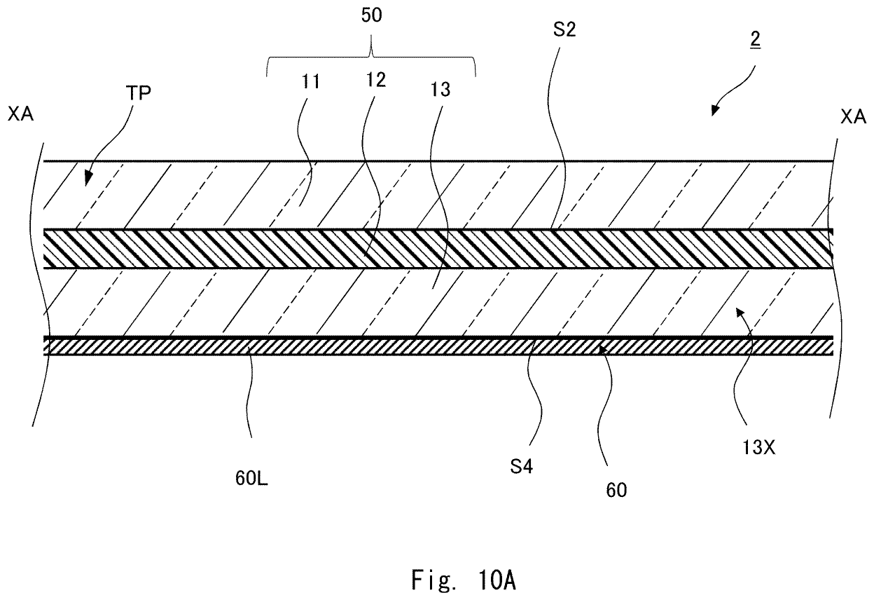

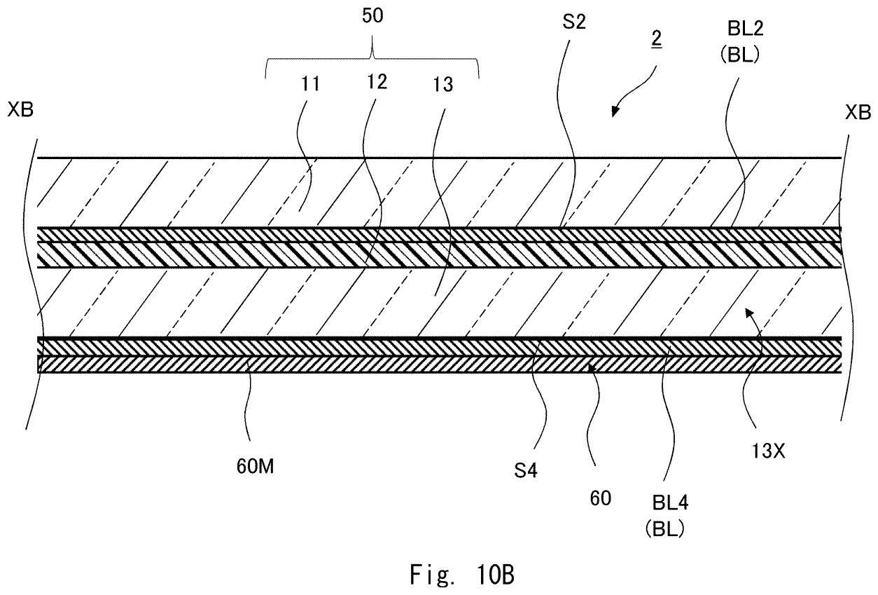

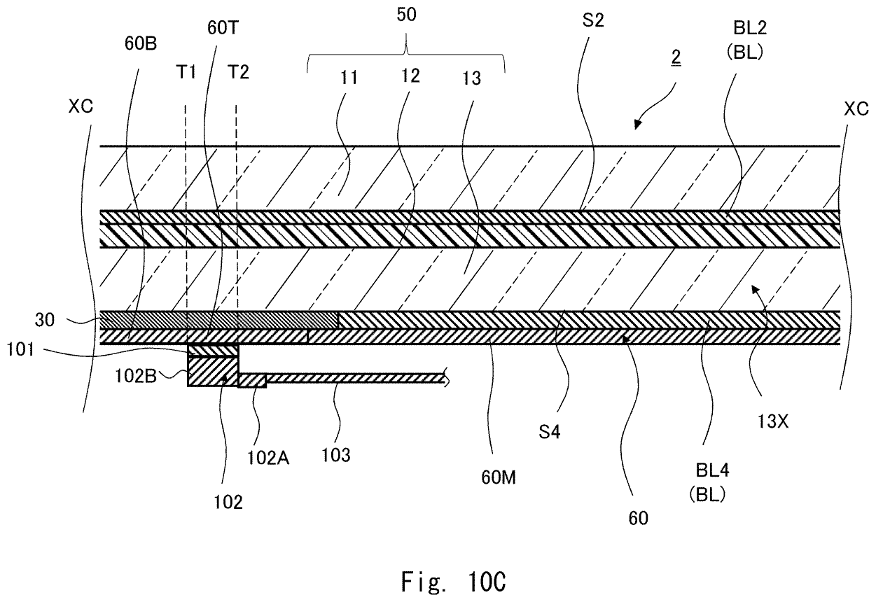

FIG. 8A is an overall plan view of a windshield for vehicle according to this embodiment. FIG. 8B is an overall plan view of an outer glass plate. FIG. 9 is a partially enlarged plan view of FIG. 8A. FIGS. 8A and 9 show a state before terminals are connected. In each of FIGS. 8A, 8B and 9, the front side of the drawing is the inside of the vehicle and the rear side thereof is the outside thereof. FIG. 10A is a cross-sectional diagram taken along a line XA-XA in FIG. 9. FIG. 10B is a cross-sectional diagram taken along a line XB-XB in FIG. 9. FIG. 10C is a cross-sectional diagram taken along a line XC-XC in FIG. 9. In each of FIGS. 10A to 10C, the upper side of the drawing is the outside of the vehicle and the lower side thereof is the inside thereof. These drawings are all schematic diagrams, and the scales of components are changed from those of the actual ones on a drawing-by-drawing basis for facilitating the visual recognition of them. The same reference numerals (or symbols) as those in the first embodiment are assigned to the same components/structures as those in the first embodiment, and descriptions thereof are omitted.

The planar shape of the windshield for vehicle 2 can be designed as desired, and is, for example, a roughly trapezoidal plate-like shape in a plan view in which the plate is curved over the entire the length as shown in FIG. 8A.

As shown in FIG. 10C, the windshield for vehicle 2 according to this embodiment includes a laminated glass 50 in which an outer glass plate 11 (a glass plate on the exterior side of the vehicle, a second glass plate in this embodiment) and an inner glass plate 13 (a glass plate on the internal side of the vehicle, a first glass plate in this embodiment) are bonded together with an intermediate film 12 interposed therebetween.

In this embodiment, the laminated glass 50 includes a glass plate with a terminal 13X including the inner glass plate 13, a conductor 60 that is formed on the interior surface S4 of the inner glass plate 13 (the surface on the side of the inner glass plate 13 opposite to the intermediate film 12 side), is made of a material containing silver and glass frit, and includes a terminal joint portion 60T to which a terminal 102 is joined, and the terminal 102 that is joined the terminal joint portion 60T of the conductor 60 through lead-free solder 101.

As shown in FIG. 8A, the windshield for vehicle 2 includes an optical apparatus mounting area OP on which am optical apparatus is mounted, and a light-transmitting portion TP which is located inside the optical apparatus mounting area OP and through which external incident light entering the optical apparatus and/or outgoing light exiting from the optical apparatus passes.

As shown in the drawing, it is possible to form the light-transmitting portion TP in an area relatively close to one edge 50E (the upper edge in the example shown in the drawing) of the windshield for vehicle 2.

The optical apparatus can include, for example, an optical device that acquires information about an area ahead of a vehicle, such as an ADAS (Advanced Driver Assistance systems) camera, LiDAR (Light Detection And Ranging), a radar, and an optical sensor, and a housing referred to as a bracket or the like that houses the optical device in order to perform automatic driving and/or to prevent a collision accident.

The shapes of the optical apparatus mounting area OP and the light-transmitting portion TP can be designed as appropriate according to the shape of the optical apparatus, and examples of shapes include roughly-trapezoidal shapes or roughly-rectangular shapes. The shapes of the optical apparatus mounting area OP and the light-transmitting portion TP can be similar to each other or dissimilar from each other. In the example shown in the drawing, both the optical apparatus mounting area OP and the light-transmitting portion TP have roughly trapezoidal shapes.

Like the first embodiment, as shown in FIGS. 8A and 8B, the windshield for vehicle 2 according to this embodiment includes at least one light-shielding layer BL in an area including the peripheral area. The area where at least one light-shielding layer BL is formed is referred to as a light-shielding area of the laminated glass 50, and the area inside the light-shielding area is referred to as a non-light-shielding area.

The number of light-shielding layers BL, the glass surface where the light-shielding layer(s) BL is formed, and the formation area of the light-shielding layer(s) BL can be designed as appropriate. In the example shown in the drawing, the windshield for vehicle 2 can include, as the at least one light-shielding layer BL, a plurality of light-shielding layers (the light-shielding layers BL2 and BL4). The plurality of light-shielding layers are formed on different glass surfaces. Specifically, as shown in FIG. 10C, the light-shielding layer BL2 is formed in a predetermined area on the interior surface S2 (the surface on the intermediate film 12 side) of the outer glass plate 11, and the light-shielding layer BL4 is formed in a predetermined area on the interior surface S4 (the surface on the side opposite to the intermediate film 12) of the inner glass plate 13.

As shown in FIG. 8A, the formation area of the light-shielding layer BL4 can include the part of the optical apparatus mounting area OP other than the light-transmitting portion TP, the area around the optical apparatus mounting area OP, and the peripheral area of the windshield for vehicle 2.

In the example shown in the drawing, the formation area of the light-shielding layer BL4 includes the part of the optical apparatus mounting area OP other than the light-transmitting portion TP, the area around the optical apparatus mounting area OP, the area R41 which is the part of the roughly trapezoidal area outlined by one edge 50E (the upper edge in the example shown in the drawing) of the laminated glass 50 and sides B41 to B43 thereof other than the light-transmitting portion TP, and the peripheral area R42 of the windshield for vehicle 2. Note that although details will be described later, a non-formation area NBL4 of the light-shielding layer BL4 is partially present in the area R41.

In the example shown in the drawing, the light-shielding layer BL4 surrounds all the four sides of the light-transmitting portion TP. However, the light-shielding layer BL4 needs to surround only at least a part of the light-transmitting portion TP. For example, the light-shielding layer BL4 may only surround three sides of the light-transmitting portion TP having a roughly trapezoidal shape or a roughly rectangular shape.

The wavelength range of light that passes through the light-transmitting portion TP is not limited to any particular wavelength ranges, and examples of the wavelength range include a visible light range, an infrared light range, and a range extending from the visible light range to the infrared light range.

As shown in FIG. 9, in this embodiment, the conductor 60 includes an electric function portion composed of an electric heating line 60L formed inside the light-transmitting portion TP. The conductor 60 further includes a feeding portion composed of a pair of feeding electrodes (a pair of busbars) 60B formed outside the light-transmitting portion TP. The conductor 60 further includes two connection lines 60M that are formed outside the light-transmitting portion TP and connect the electric heating line 60L to the pair of feeding electrodes (the pair of busbars) 60B.

It is possible to improve the accuracy of the sensing of the optical apparatus by providing an electric heating line 60L for preventing condensation and frost in the area including the light-transmitting portion TP located in front of the optical device such as a camera and a radar included in the optical apparatus.

The number of electric heating lines 60L, the number of connection lines 60M, the number of feeding electrodes 60B, the line pattern and arrangement pattern of the electric heating lines 60L and the connection lines 60M, the shape and arrangement pattern of feeding electrodes 60B, and the like can be designed as appropriate.

For example, it is preferred that the electric heating line 60L is, in a plan view, repeatedly folded back so as to pass through the light-transmitting portion TP a plurality of times because, by this configuration, frost and water droplets formed in the light-transmitting portion TP can be efficiently removed. The line width of the electric heating line 60L and/or the connection line 60M may be substantially uniform from one feeding electrode to another feeding electrode, or may be changed between one feeding electrode to another feeding electrode.

As shown in FIG. 10C, in this embodiment, the conductor 60 is formed on the interior surface S4 of the inner glass plate 13.

Like the first embodiment, each of the pair of feeding electrodes (the pair of busbars) 60B includes a terminal joint portion 60T, and a terminal 102 is joined to the terminal joint portion 60T of the conductor 60 through lead-free solder 101. The feeding member 103 composed of a round lead or foil lead is fixed to the terminal 102.

Like the first embodiment, the terminal joint portion 60T of the conductor 60 is a part directly below the lead-free solder 101. In the drawing, the area of the terminal joint portion 60T corresponds to an area interposed between two broken lines T1 and T2. Note that the position of the terminal joint portion 60T of the conductor 60 is not clearly defined in advance. In the feeding electrode 60B, the part that is located directly below the lead-free solder 101 after the terminal 102 is joined thereto through the lead-free solder 101 is the terminal joint portion 60T.

Like the first embodiment, as shown in FIG. 10C, the glass plate with the terminal 13X includes the inorganic thin film 30 between the inner glass plate 13 and the terminal joint portion 60T, the inorganic thin film 30 including at least one metal compound layer, having an overall thickness of 1,000 nm or smaller, and having a single-layer structure or a laminated structure, and at least the outermost surface of the inorganic thin film 30 having an insulating property. The inorganic thin film 30 is formed so as to contain at least the formation area of the terminal joint portion 60T. In the above-described structure, the presence of the inorganic thin film 30 can enhance the breaking strength of the inner glass plate 13 to which the terminal has not been attached yet or has already been attached.

The structure and preferred embodiment of the inorganic thin film 30 are similar to those in the first embodiment. Further, the laminated structure of Feeding Electrode 60B/Inorganic Thin Film 30/Inner Glass Plate 13 including Terminal 102/Lead-Free Solder 101/Terminal Joint Portion 60T is similar to the laminated structure described above with reference to FIGS. 4 and 5 in the first embodiment.

Even in this embodiment, the inorganic thin film 30 can be a functional film having a low reflection function, a low emission function, a water repellent function, an electric heating function, an antifogging function, an antifouling function, an infrared-light blocking function, an ultraviolet-light blocking function, a p-polarized-light reflection function, or a combination thereof or the like. In this case, a functional film may be formed in the non-light-shielding area of the laminated glass 50 on the interior surface S4 of the inner glass plate 13.

In other words, when an inorganic thin film is formed as the functional film in the non-light-shielding area of the laminated glass 50 on the interior surface S4 of the inner glass plate 13, this inorganic thin film can also be formed as the inorganic thin film 30 for reinforcing the terminal joint portion 60T in the area including the formation area of the terminal joint portion 60T. In this case, the inorganic thin film 30 can be formed in the same process as the process for the inorganic thin film formed as the functional film in the non-light-shielding area of the laminated glass 50.

As described above, the windshield for vehicle 2 according to this embodiment includes at least one light-shielding layer BL.

As shown in FIG. 8A, in this embodiment, a light-shielding layer BL4 (a first light-shielding layer) is formed in an area including the peripheral area on the interior surface S4 of the inner glass plate 13. However, there is an area where the light-shielding layer BL4 is not formed inside the light-shielding area of the laminated glass 50.

Like the first embodiment, the terminal joint portion 60T is preferably formed directly above the inorganic thin film 30. In other words, the glass plate with the terminal 13X preferably does not include the light-shielding layer BL4 between the inorganic thin film 30 and the terminal joint portion 60T.

Further, the glass plate with the terminal 13X preferably does not include the light-shielding layer BL4 between the inner glass plate 13 and the inorganic thin film 30 at least inside the formation area of the terminal joint portion 60T.

In FIGS. 8A and 9, the symbol NBL4 indicates the non-formation area of the light-shielding layer BL4. The non-formation area NBL4 of the light-shielding layer BL4 includes the formation area of the terminal joint portion 60T, and preferably includes the formation area of the feeding portion (the pair of feeding electrodes 60B) as shown in the drawing.

Note that in practice, the overall thickness of the inorganic thin film 30 is very small relative to the thickness of the light-shielding layer BL4. However, in FIG. 10C, the inorganic thin film 30 is shown with a relatively large thickness for facilitating the visual recognition thereof.

Further, although the inorganic thin film 30 and the light-shielding layer BL4 do not overlap each other and are adjacent to each other with no space therebetween in FIG. 10C, the inorganic thin film 30 and the light-shielding layer BL4 may partially overlap each other. In the overlapping part, the light-shielding layer BL4 is disposed over the inorganic thin film 30.

Further, there may be some space between the inorganic thin film 30 and the light-shielding layer BL4.

Like the first embodiment, in this embodiment, the light-shielding layer BL4 is formed in the part of the area on the interior surface S4 of the inner glass plate 13 other than the terminal joint portion 60T inside the light-shielding area. Further, most of the conductor 60, i.e., the part of the conductor 60 that includes the electric function portion composed of at least one electric heating line 60L but does not include at least terminal joint portion 60T, is formed on this light-shielding layer BL4.

Further, in this embodiment, as shown in FIG. 10C, the light-shielding layer BL2 (the second light-shielding layer) covering, in a plan view, at least the terminal joint portion 60T is formed on the light-shielding area on the interior surface S2 of the outer glass plate 11. The formation area of the light-shielding layer BL2 can be designed as appropriate inside the range covering the terminal joint portion 60T, and preferably covers, in a plan view, the feeding portion (the pair of feeding electrodes 60B).

As shown in FIG. 8B, like the light-shielding layer BL4, the formation area of the light-shielding layer BL2 can include the part of the optical apparatus mounting area OP other than the light-transmitting portion TP, the area around the optical apparatus mounting area OP, and the peripheral area of the windshield for vehicle 2.

In the example shown in the drawing, like the light-shielding layer BL4, the formation area of the light-shielding layer BL2 includes the part of the optical apparatus mounting area OP other than the light-transmitting portion TP, the area around the optical apparatus mounting area OP, the area R21 which is the part of the roughly trapezoidal area outlined by one edge 50E (the upper edge in the example shown in the drawing) of the laminated glass 50 and sides B21 to B23 thereof other than the light-transmitting portion TP, and the peripheral area R22 of the windshield for vehicle 2. The non-formation area of the light-shielding layer BL2 does not have to be provided in a part of the area R21.

Note that the planar shape of the area R21 of the light-shielding layer BL2 and the planar shape of the area R41 of the light-shielding layer BL4 can be designed independently of each other, and the planar shapes of these areas may be identical to each other or different from each other. For example, the planar shape of the area R21 of the light-shielding layer BL2 may be designed so as to have a width larger than that of the area R41 of the light-shielding layer BL4.

Similarly, the planar shape of the area R22 of the light-shielding layer BL2 and the planar shape of the area R42 of the light-shielding layer BL4 can be designed independently of each other, and the planar shapes of these areas may be identical to each other or different from each other.

As shown in FIGS. 8A, 8B, 9 and 10A, in this embodiment, the light-shielding layer BL is not formed inside the light-transmitting portion TP.

As shown in FIGS. 9 and 10B, at least a part of the connection line 60M is formed on the light-shielding layer BL4. As shown in FIG. 9, it is preferred that most of the connection line 60M except for the part adjacent to the feeding electrode 60B is formed on the light-shielding layer BL4.

The “part adjacent to the feeding electrode” of the connection line is, for example, a range 4.0 mm or shorter from the feeding electrode.

The non-formation area NBL4 of the light-shielding layer BL4 can be designed as appropriate in the range in which the non-formation area NBL4 satisfies the condition that it should include the formation area of the terminal joint portion 60T. As shown in FIG. 9, the non-formation area NBL4 of the light-shielding layer BL4 is preferably designed so that the non-formation area NBL4 includes the formation area of the terminal joint portion 60T and most of the connection line 60M except for the part adjacent to the feeding electrode 60B is disposed on the light-shielding layer BL4.

In the above-described structure, it is possible to make a design so that the feeding portion of the conductor 60 included in glass plate with the terminal 13X is not visible to people outside the vehicle.

Further, the above-described structure, since no glass frit component derived from the material for forming the light-shielding layer is present in the terminal joint portion 60T, it is possible, for the terminal joint portion formed on the light-shielding layer, to reduce the amount of the glass frit component present on or near the surface of the terminal joint portion 60T. The effect for reinforcing the terminal joint portion 60T obtained by the inorganic thin film 30, combined with the effect for reducing the glass frit component on or near the surface of the terminal joint portion 60T, can effectively enhance the breaking strength of the glass plate with the terminal 13X.

Note that in the technology disclosed in the present disclosure, since the effect for reinforcing the terminal joint portion 60T by the inorganic thin film 30 can be obtained, the glass plate with the terminal 13X may include the light-shielding layer BL4 between the inorganic thin film 30 and the terminal joint portion 60T.

(Manufacturing Method)

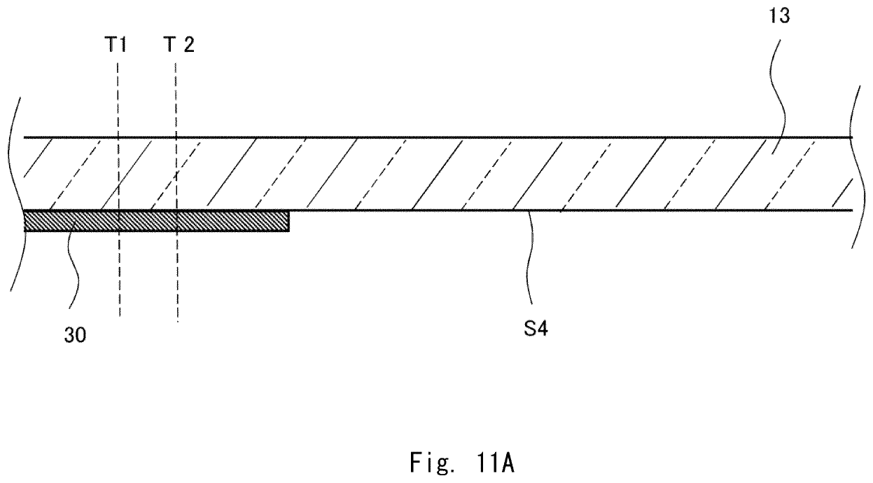

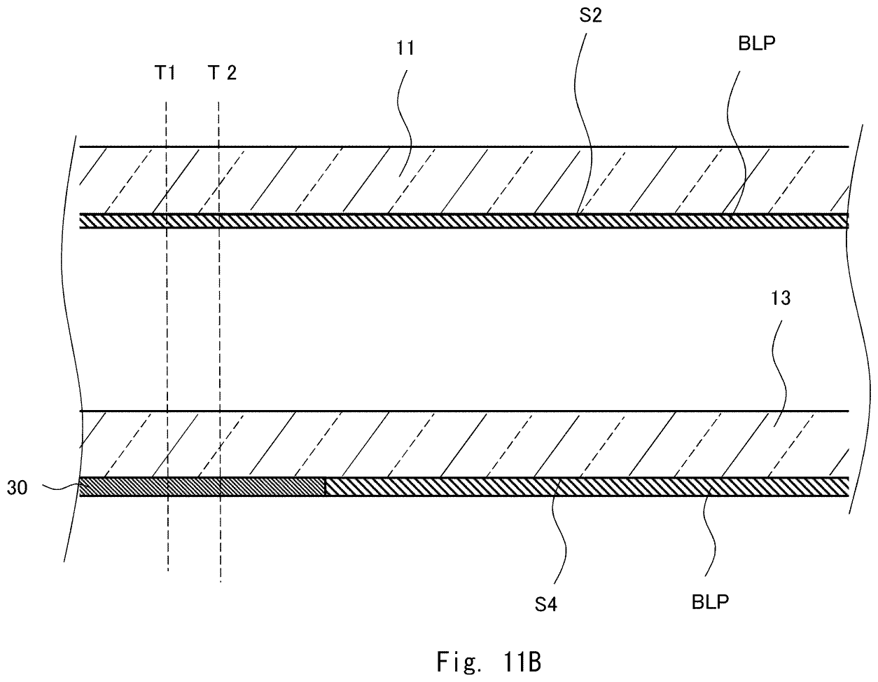

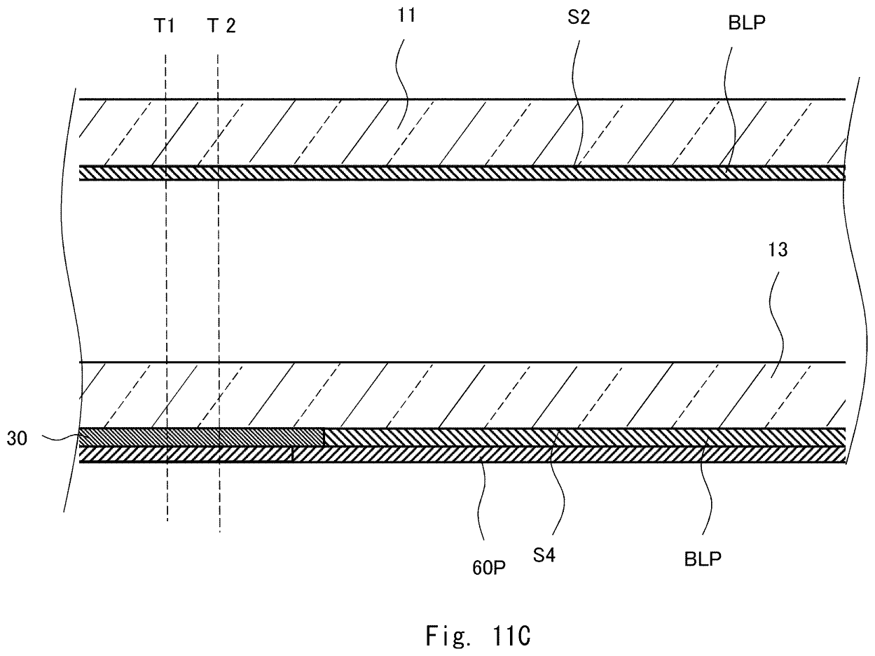

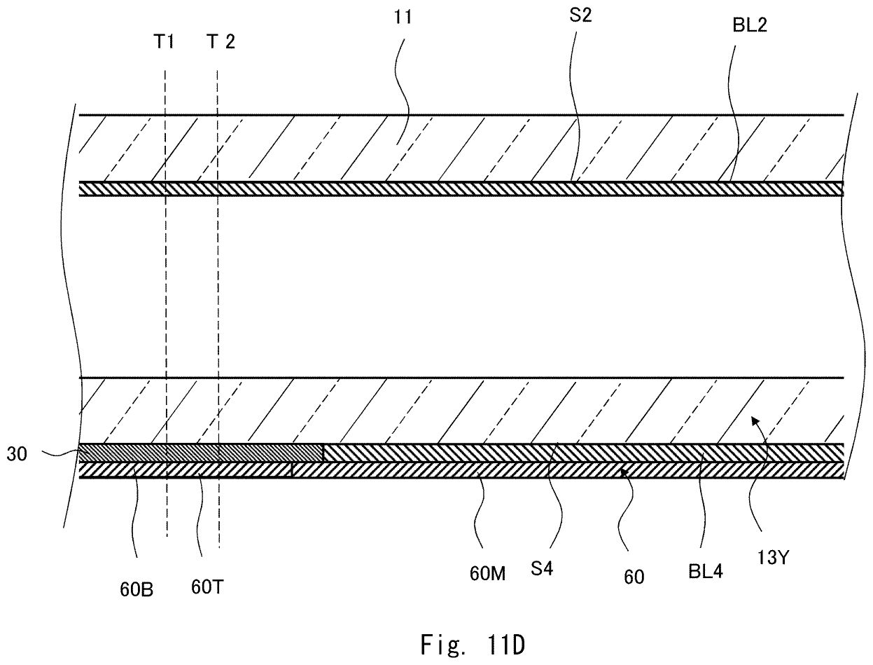

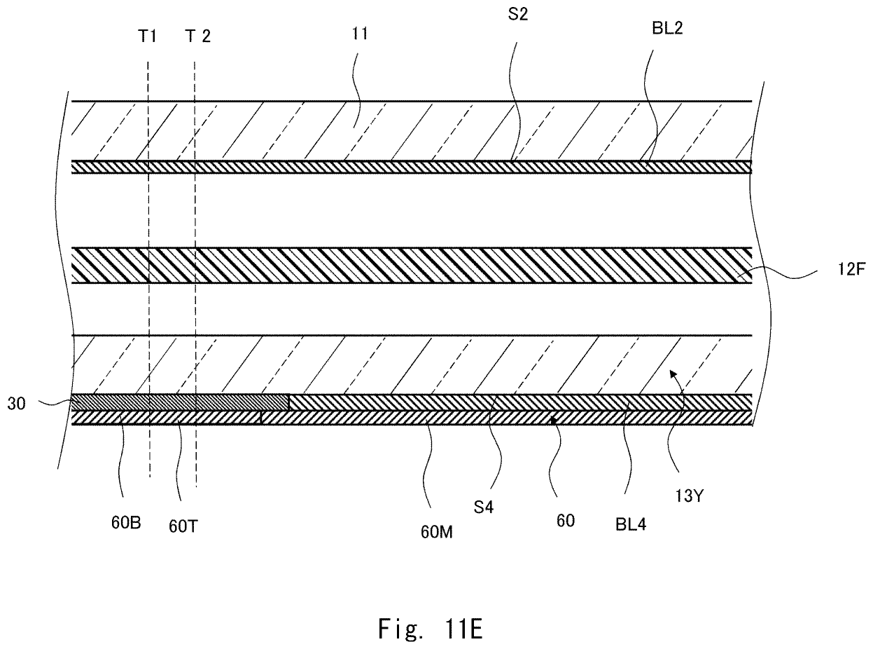

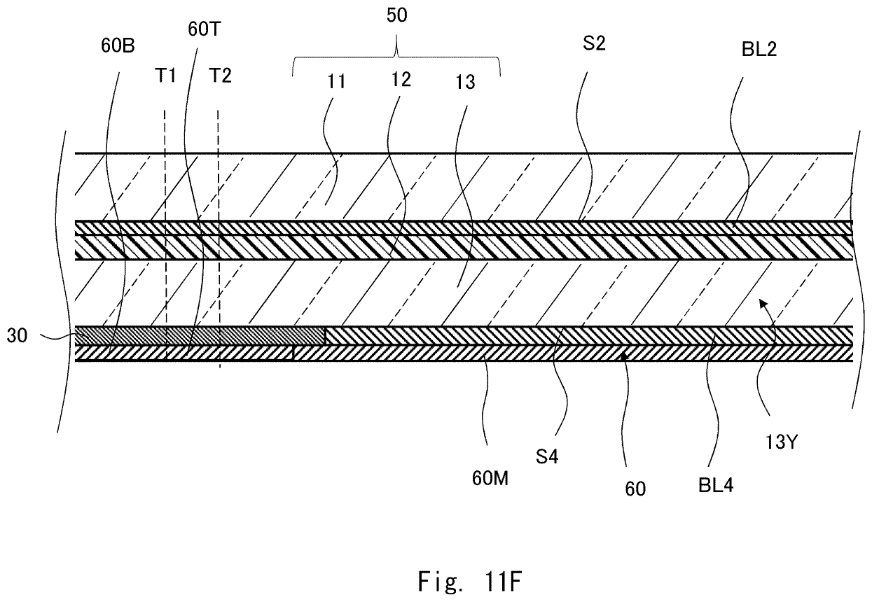

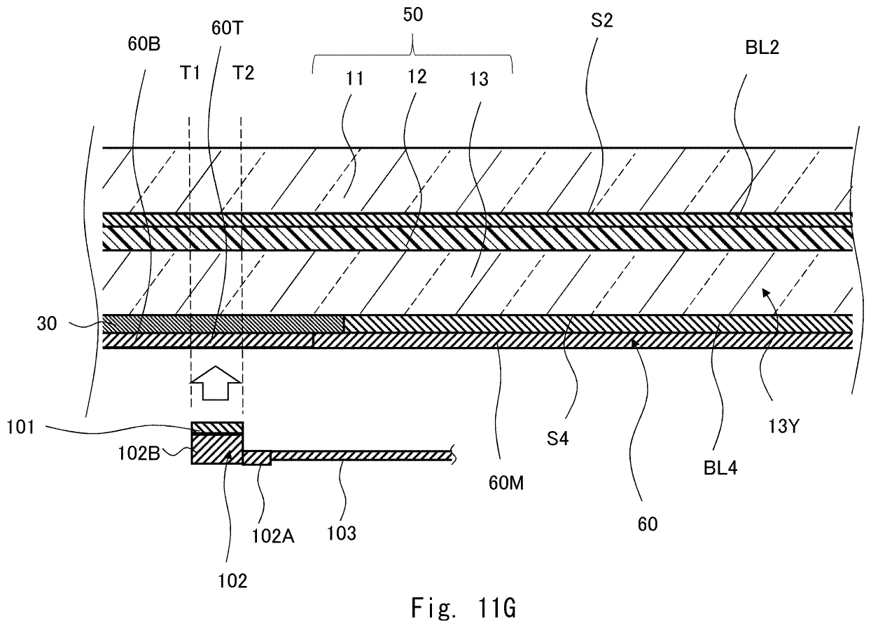

An example of a method for manufacturing a windshield for vehicle according to this embodiment will be described with reference to the drawings. FIGS. 11A to 11G are schematic cross-sectional diagrams corresponding to FIG. 10C.

(Step (S11))

Firstly, as shown in FIG. 11A, in the formation area of at least a terminal joint portion 60T on an interior surface S4 of an inner glass plate 13 (a glass plate on the interior side of the vehicle, a first glass plate in this embodiment), an inorganic thin film 30, which includes at least one metal compound layer, has an overall thickness of 1,000 nm or smaller, has a single-layer structure or a laminated structure, and of which at least the outermost surface has an insulating property, is formed by a vapor deposition method. The method for forming the film is similar to the method according to the first embodiment.

(Step (S12))

Next, as shown in FIG. 11B, a ceramic paste layer BLP is formed by applying a ceramic paste containing a black pigment and glass frit, which is a material for a light-shielding layer BL4 (a first light-shielding layer in this embodiment), to a predetermined area on the interior surface S4 of the inner glass plate 13, on which the inorganic thin film 30 has been formed, other than the formation area of the terminal joint portion 60T of the conductor 60, and drying the applied ceramic paste.

Further, a ceramic paste layer BLP is formed by applying a ceramic paste containing a black pigment and glass frit, which is a material for a light-shielding layer BL2 (a second light-shielding layer in this embodiment), to a predetermined area including the formation area of the terminal joint portion 60T of the conductor 60 on the interior surface S2 of the outer glass plate 11, and drying the applied ceramic paste.

The conditions for drying the ceramic paste layer are similar to those in the first embodiment.

(Step (S13))

Next, as shown in FIG. 11C, a conductive paste layer 60P is formed by applying a silver-containing paste containing silver and glass frit, which is a material for a conductor 60, to the interior surface S4 of the inner glass plate 13, on which the inorganic thin film 30 has been formed, and drying the applied silver-containing paste. The conditions for drying the conductive paste layer are similar to those in the first embodiment.

(Step (S14))

Next, the outer glass plate 11 and the inner glass plate 13, which have undergone the above-described steps, are heated to a temperature equal to or higher than their softening points, and each of the glass plates is bent into a desired shape. In this step, the ceramic paste layer BLP and the conductive paste layer 60P are simultaneously fired, so that light-shielding layers BL2 and BL4 and the conductor 60 are formed.

After the firing, each of the glass plates is slowly cooled. The firing temperature is equal or close to that in the first embodiment. After the above-described steps, as shown in FIG. 11D, an outer glass plate 11 including the light-shielding layer BL2 and a glass plate with a conductor 13Y are obtained.

(Step (S15))

Next, as shown in FIG. 11E, the outer glass plate 11 including the light-shielding layer BL2 and the glass plate with the conductor 13Y are bonded together with a resin film 12F made of a material for an intermediate film 12 interposed therebetween (a bonding process). The bonding method is similar to the method in the first embodiment.

After the above-described steps, a laminated glass 50 is obtained as shown in FIG. 11F.

(Step (S16))

Next, as shown in FIG. 11G, a terminal 102 is joined to the terminal joint portion 60T included in each feeding electrode 60B through lead-free solder 101. The joining method is similar to the method in the first embodiment.

Through the above-described steps, a windshield for vehicle 2 according to this embodiment is manufactured.

As described above, in the windshield for vehicle according to the present disclosure, the glass plate with the terminal includes the inorganic thin film between the glass plate and the terminal joint portion, the inorganic thin film including at least one metal compound layer, having an overall thickness of 1,000 nm or smaller, and having a single-layer structure or a laminated structure, and at least the outermost surface of the inorganic thin film having an insulating property. In the above-described structure, the presence of the inorganic thin film can enhance the breaking strength of the glass plate to which terminals have already been attached.

According to the present disclosure, it is possible to provide a windshield for vehicle which includes a part where a conductor and a terminal are joined to each other by using lead-free solder, and of which the breaking strength of the glass plate to which the terminal has already been attached can be enhanced.

Further, according to the present disclosure, it is possible to, by appropriately disposing a plurality of light-shielding layers, design a windshield for vehicle so that its feeding portion is not visible to people outside the vehicle.

### EXAMPLES

The present disclosure will be described hereinafter based on examples, but the present disclosure is not limited to these examples. Example 2 is an example according to the present disclosure, and Example 11 is a comparative example.

[Evaluation Items and Evaluation Method]

The evaluation items and the evaluation method are as follows. (Breaking Strength) Ring bending tests were carried out according to ASTM-C1499-1 by using an autograph (“AGS-X” manufactured by Shimadzu Corporation, Maximum load: load 5 kN) under an environment having a normal temperature (20 to 25° C.).

A glass plate to which a terminal had not been attached yet (a glass plate with a conductor) or a glass plate to which a terminal had already been attached (a glass plate with a terminal) was placed on a support ring having a diameter of 98 mm in such a manner that the surface on which the conduct had been formed faced downward. A load ring having a diameter of 46 mm was placed on this glass plate for evaluation. The central axes of the support ring, the glass plate, and the load ring are aligned with each other.

A load was applied to the periphery of the conductor of the above-described glass plate for evaluation by the load ring. The load was continuously increased so that the displacement of the glass plate became 1 mm/min, and the load at the time when the glass plate was broken was defined as its breaking strength.

For each glass plate, a total of four or five samples were measured, and their average values were used as data on the breaking strength.

### Examples 1 and 2

For each of Examples 1 and 2, an un-tempered glass plate (G1) having a shape of 100 mm×100 mm square and a thickness of 2.0 mm (“VFL” manufactured by AGC Inc., green) was prepared. An inorganic thin film having a laminated structure was formed over the entire area of one of the surfaces of this glass plate by a known sputtering method.

In Example 1, an inorganic thin film (IM1) having a two-layered structure (total thickness: 186 nm) was formed by successively forming a Zr-doped TiO₂ film (65 nm thick, Zr content: 35 mass %) and a SiO₂ film (121 nm thick). This inorganic thin film was composed of three insulating metal compound layers and could function as a p-polarized reflective film.

In Example 2, an inorganic thin film (IM2) having a five-layered structure (total thickness: 255 nm) was formed by successively forming a Zr-doped TiO₂ film (10 nm thick, Zr content: 35 mass %), a SiO₂ film (35 nm thick), an indium tin oxide (ITO) film (120 nm thick), a SiO₂ film (70 nm thick), and a Zr-doped SiO₂ film (20 nm thick, Zr content: 10 mass %). This inorganic thin film was composed of four insulating metal compound layers and one conductor layer (i.e., the ITO layer) sandwiched between two of the four insulating metal compound layers, and its outermost surface layer was an insulating metal compound layer. This inorganic thin film could function as a low-emission film.

Next, in each of the examples, a conductive paste layer was formed by applying a commercial-available silver-containing paste (AgP1) for forming a conductor, containing a silver powder and glass frit to the formed inorganic thin film by a screen-printing method and drying the applied silver-containing paste. The drying conditions were 120° C. and 10 minutes.

Next, the conductive paste layer was fired. The conductive past layer was heated from a normal temperature (20 to 25° C.) to 600° C. at a temperature rising rate of about 180° C. per minute, fired at 600° C. for 400 seconds, and then naturally cooled to a normal temperature (20 to 25° C.). Through the above-described processes, a conductor was formed.

The planar shape of the conductor was a 50 mm×50 mm square, and its center and diagonal line were aligned with the center and diagonal line, respectively, of the glass plate. The thickness of the conductor was about 7 μm.

The surface of the conductor was polished by using a commercially-available polishing eraser in a manner common to the manufacturing of windshields for vehicle. The thickness of the polished conductor was about 6 μm.

Through the above-described processes, a glass plate with a conductor having a laminated structure of Conductor/Inorganic Thin Film/Glass Plate was manufactured. The breaking strength of this glass plate with the conductor to which a terminal had not been attached yet was measured.

In each of the examples, a crimped brass terminal composed of a cylindrical feeding member joint portion into which the tip (a conductor-exposed portion) of a wire harness is inserted and a bridge portion including solder joint portions at both ends thereof as shown in FIG. 4 was joined to the conductor of the obtained glass plate with the conductor by using SnAg-based lead-free solder (Sn: 98 mass %, Ag: 2.0 mass %, melting point: about 220° C.).

The specific method is as follows.

Firstly, 0.04 g of lead-free solder was placed on the tip of a soldering iron and melted by heating. This solder is referred to as preparatory solder.

Then, 0.05 g of a lead-free solder chip was attached to each solder joint portion of a terminal. This terminal was placed on the terminal joint portion of the conductor. In this state, the lead-free solder chip was heated and melted by pressing the tip of the soldering iron of which the temperature was set to 300° C. against the solder joint portion of the terminal. After that, the soldering iron was released from the terminal, and the lead-free solder was solidified by natural cooling.

Through the above-described processes, a glass plate with a terminal was manufactured.

When one hour had elapsed after the terminal was joined to the conductor through the lead-free solder, the breaking strength of the glass plate with the conductor was measured.

### Example 11

A glass plate with a conductor having a laminated structure of Conductor/Glass Plate was manufactured in a manner similar to Example 2, except that no inorganic thin film was formed. By using the obtained glass plate with the conductor, a glass plate with a terminal was manufactured in a manner similar to Examples 1 and 2. Like Examples 1 and 2, the breaking strength of the glass plate with the conductor to which the terminal had not been attached yet, and the breading strength of the glass plate with the terminal were measured.

[Evaluation Result]

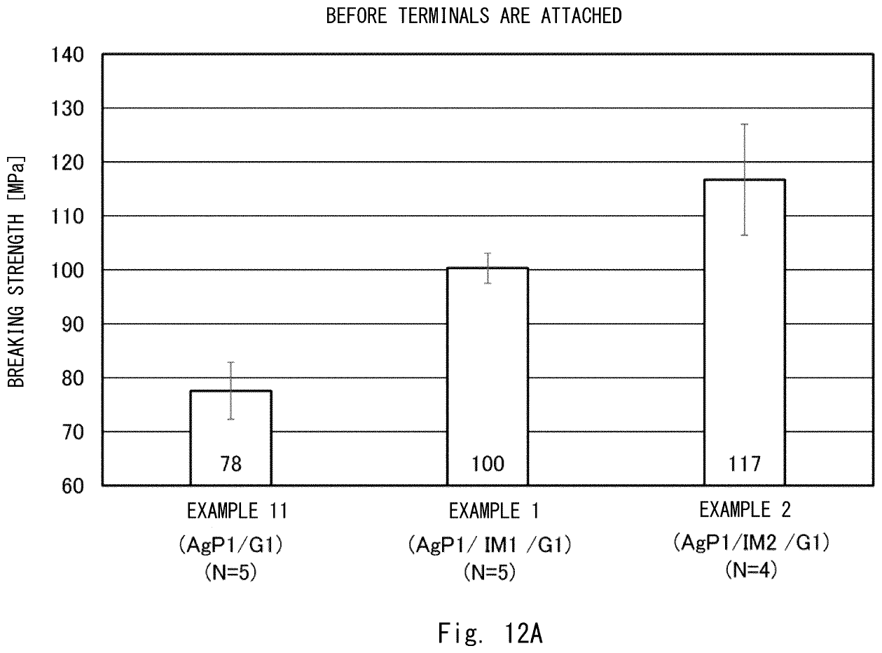

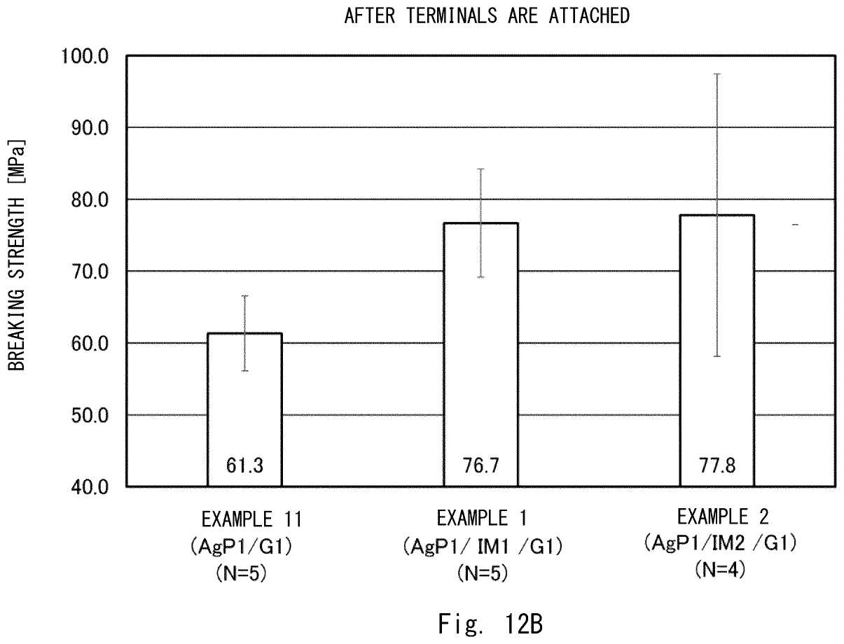

FIG. 12A shows results of evaluations of the glass plates to which terminals had not been attached yet (the glass plates with conductors). FIG. 12B shows results of evaluations of the glass plates to which terminals had already been attached (the glass plates with terminals). In the drawings, N represents the number of samples used to calculate an average value.

As shown in FIG. 12A, when the glass plates to which terminals had not been attached yet (the glass plates with conductors) are compared with each other, in Examples 1 and 2 in each of which an inorganic thin film was formed between the glass plate and the conductor, the breaking strength of the glass plate was meaningfully improved compared with Example 11 in which no inorganic thin film was formed between the glass plate and the conductor.

As shown in FIG. 12B, when the glass plates to which terminals had already been attached (the glass plates with terminals) are compared with each other, in Examples 1 and 2 in each of which an inorganic thin film was formed between the glass plate and the conductor, the breaking strength of the glass plate was meaningfully improved compared with Example 11 in which no inorganic thin film was formed between the glass plate and the conductor.

The present disclosure is not limited to the above-described embodiments and examples, and the designs of them can be modified as appropriate as long as they do not deviate from the scope and spirit of the present disclosure.

The first and second embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A windshield for vehicle comprising a laminated glass in which a first glass plate and a second glass plate are bonded together with an intermediate film interposed therebetween, wherein
the laminated glass comprises a glass plate with a terminal, comprising the first glass plate, a conductor formed on an interior surface of the first glass plate, and the terminal, the conductor being made of a material containing silver and glass frit, and comprising a terminal joint portion to which the terminal is joined, the terminal being joined to the terminal joint portion of the conductor through lead-free solder,
the conductor comprises an electric function portion or is electrically connected to an electric function portion,
the conductor comprises a feeding portion for feeding electricity to the electric function portion, and the feeding portion comprises the terminal joint portion, and
the glass plate with the terminal further comprises an inorganic thin film between the first glass plate and the terminal joint portion, the inorganic thin film including at least one metal compound layer, having an overall thickness of 1,000 nm or smaller, and having a single-layer structure or a laminated structure, and at least an outermost surface of the inorganic thin film having an insulating property.

2. The windshield for vehicle according to claim 1, wherein the inorganic thin film is a vapor deposition film.

3. The windshield for vehicle according to claim 1, wherein
the terminal joint portion is formed directly above the inorganic thin film,
a first light-shielding layer is formed between the interior surface of the first glass plate and at least a part of the conductor other than the terminal joint portion, and
a second light-shielding layer covering the terminal joint portion of the conductor is formed, in a plan view, on an exterior surface of the first glass plate and at least one of two surfaces of the second glass plate.

4. The windshield for vehicle according to claim 1, wherein the inorganic thin film includes at least one metal compound layer containing at least one metal compound selected from the group consisting of an oxide, a nitride, and an oxynitride of at least one metal element selected from the group consisting of B, Al, Si, Ti, Cr, Ni, Zn, Ga, Y, Zr, Nb, In, Sn, Hf, Ta and W.

5. The windshield for vehicle according to claim 1, wherein
the inorganic thin film includes at least one insulating metal compound layer containing at least one insulating metal compound selected from the group consisting of an oxide, a nitride, and an oxynitride of at least one metal element selected from the group consisting of B, Al, Si, Ti, Cr, Ni, Ga, Y, Zr, Nb, Hf, Ta and W, and
when the inorganic thin film has the laminated structure, at least the outermost surface layer of the inorganic thin film is the insulating metal compound layer.

6. The windshield for vehicle according to claim 1, wherein
the inorganic thin film includes at least one insulating metal compound layer and at least one conductor layer containing at least one substance selected from the group consisting of a metal and a conductive metal compound, and
at least the outermost surface layer of the inorganic thin film is the insulating metal compound layer.

7. The windshield for vehicle according to claim 1, wherein the inorganic thin film is a functional film having at least one function selected from the group consisting of a low reflection function, a low emission function, a water repellent function, an electric heating function, an antifogging function, an antifouling function, an infrared-light blocking function, an ultraviolet-light blocking function, and a p-polarized-light reflection function.

8. The windshield for vehicle according to claim 1, wherein the interior surface of the first glass plate is a surface on an intermediate film side of the first glass plate and has an exposed portion not covered by the second glass plate, and the terminal joint portion of the conductor is formed in this exposed portion.

9. The windshield for vehicle according to claim 1, wherein the interior surface of the first glass plate is a surface on a side of the first glass plate opposite to an intermediate film side thereof.

10. The windshield for vehicle according to claim 9, wherein
a first light-shielding layer is formed between the interior surface of the first glass plate and at least a part of the conductor other than the terminal joint portion, and
a second light-shielding layer covering the terminal joint portion of the conductor is formed, in a plan view, on a surface on the intermediate film side of the second glass plate.

11. The windshield for vehicle according to claim 10, wherein
the glass plate with the terminal includes an optical apparatus mounting area and a light-transmitting portion, the optical apparatus mounting area being, in a plan view, an area in which an optical apparatus is mounted, and the light-transmitting portion being a portion which is located inside the optical apparatus mounting area and through which external incident light entering the optical apparatus and/or outgoing light exiting from the optical apparatus passes,
the first light-shielding layer is formed so as to surround, in the plan view, at least a part of the light-transmitting portion, and
the conductor comprises an electric heating line formed inside the light-transmitting portion, the feeding portion formed outside the light-transmitting portion, and a connection line formed outside the light-transmitting portion and connecting the electric heating line and the feeding portion.

12. The windshield for vehicle according to claim 1, wherein a feeding member formed of a round lead or a foil lead is fixed to the terminal.

13. A method for manufacturing a windshield for vehicle, wherein
the windshield for vehicle comprises:
a laminated glass in which a first glass plate and a second glass plate are bonded together with an intermediate film interposed therebetween; and
the laminated glass comprising a glass plate with a terminal, comprising the first glass plate, a conductor formed on an interior surface of the first glass plate, and the terminal, the conductor comprising a terminal joint portion to which the terminal is joined, the terminal being joined to the terminal joint portion of the conductor,
the conductor comprises an electric function portion or is electrically connected to an electric function portion,
the conductor comprises a feeding portion for feeding electricity to the electric function portion, and the feeding portion comprises the terminal joint portion, and
the method comprises:
forming an inorganic thin film in at least a formation area of the terminal joint portion on the interior surface of the first glass plate by a vapor deposition method, the inorganic thin film including at least one metal compound layer, having an overall thickness of 1,000 nm or smaller, and having a single-layer structure or a laminated structure, and at least an outermost surface of the inorganic thin film having an insulating property (S11);
applying a silver-containing paste to the interior surface of the first glass plate, on which the inorganic thin film has been formed, the silver-containing paste containing silver and glass frit as a material for the conductor (S13);
forming the conductor by firing the first glass plate, to which the material for the conductor has been applied, and thereby obtaining a glass plate with a conductor (S14);
bonding the glass plate with the conductor and the second glass plate together with the intermediate film interposed therebetween (S15); and
joining the terminal to the terminal joint portion included in the conductor through lead-free solder (S16).

14. The method for manufacturing a windshield for vehicle according to claim 13, wherein
in the windshield for vehicle, the terminal joint portion is formed directly above the inorganic thin film, and a first light-shielding layer is formed between the interior surface of the first glass plate and at least a part of the conductor other than the terminal joint portion,
the method further comprises, between the steps (S11) and (S13), applying a ceramic paste containing a black pigment and glass frit, as a material for the first light-shielding layer, to the interior surface of the first glass plate, on which the inorganic thin film has been formed (S12), and
in the step (S14), the first light-shielding layer and the conductor are formed by firing the first glass plate, to which the material for the first light-shielding layer and the material for the conductor have been applied, and the glass plate with the conductor is thereby obtained.
